(19) United States
(12) Patent Application Publication
(10) Pub. No.: US 2013/0107269 A1
(43) Pub. Date: May 2, 2013

(54) ELECTRIC FIELD SPECTRUM MEASUREMENT DEVICE AND OBJECT MEASUREMENT DEVICE

(71) Applicant: Tatsutoshi Shioda, Nagaoka-shi (JP)

(72) Inventor: Tatsutoshi Shioda, Nagaoka-shi (JP)

(73) Assignee: National University Corporation Nagaoka University of Technology, Nagaoka-shi, Niigata (JP)

(21) Appl. No.: 13/581,767

(22) PCT Filed: Mar. 17, 2011
(86) PCT No.: PCT/JP2011/056479

§ 371 Date: Jan. 17, 2013

(30) Foreign Application Priority Data
Mar. 17, 2010 (JP) 2010-060034

(51) Int. Cl. G01J 3/45

(52) U.S. Cl. CPC G01J 3/45
USPC 356/451

(57) ABSTRACT

Every depth of the measurement object measures energy structural information, refractive index, transmittance, reflectance other than property information of (as for the resolution several microns), e.g., space information at the same time. A spectrum measurement device receives a reference wave propagating in a reference path and a measurement wave propagating in a measurement path having a start point same as a start point of the reference path, and derives a spectrum of the measurement wave. The space information of the measuring object, energy structural information, refractive index, transmittance, a reflective index using spectrum measurement device are derived.

### FIELD OF THE INVENTION

The present invention relates to spectrum measurement device. The spectrum measurement device receives a reference wave and a measurement wave. The spectrum measurement device can measure various kinds of spectrum of the measurement wave based on “a spectrum of the reference wave” and “a signal which are proportional to a reference wave and a square of the synthesized wave of the measurement wave”.

The present invention relates to an object measurement device which can measure space information about measured object, energy structural information, index of refraction, transmittance, reflective index, etc., using the spectrum measurement device.

### BACKGROUND OF THE INVENTION

Some techniques that measure an interference signal by a mirror-sweep is known conventionally.
patent document 1: JP2001-272335A
patent document 2: JP2003-025660A

In these techniques, a white light source is used. By using the white light source, a high resolution measurement becomes possible and these techniques can provide some simple spectrum information.

### SUMMARY OF THE INVENTION

### Problem to be Solved by the Invention

However, in the techniques of the patent document 1 and 2, the spectrum information separated in space can not be measured.

One object of the present invention is to provide a spectrum measurement device which can measure various kinds of spectra of the measurement wave based on “spectrum of reference wave” and “signal being proportional to square of a synthesized wave of reference wave and measurement wave”.

Another object of the present invention is to provide an object measurement device which can measure at least one of space information, energy structural information, refractive index, transmittance and reflective index of a measurement object by using the spectrum measurement device.

### Means to Solve the Problem

Subject matter of a first mode of a spectrum measurement device of the present invention includes (1) and (2).

(1) A spectrum measurement device which receives a reference wave propagating in a reference path and a measurement wave propagating in a measurement path having a start point same as a start point of the reference path, and derives a spectrum of the measurement wave,

wherein the spectrum is a spectrum of measurement wave that is turned back on surface or inside of a measurement object,

or a spectrum of measurement wave that penetrates the measurement object,

a spectrum of the measurement wave is measured based on spectrum of the reference wave and a signal being proportional to square of an synthesized wave of the reference wave and the measurement wave.

(2) A spectrum measurement device according to (1),
wherein spectrum of the measurement wave is power spectrum and the power spectrum is represented by next expression.

[a spectrum provided by executing Fourier transform of signal proportionate to square of an synthesized wave of a reference wave and a measurement wave]²/[a spectrum of a reference wave]

For example, the spectrum measurement device receives a reference wave Sr propagating a reference wave path, and receives a measurement wave Ss propagating in a measurement wave path having a start point same as a start point of the reference path.

And the spectrum measurement device can measure at least one of electric field spectrum Eₛ (ω), power spectrum |Eₛ(ω)|², amplitude spectrum As and phase spectrum φₛ of measurement wave Sₛ. In this case, about autocorrelation Iᵣᵣ of the reference wave Sᵣ, Fourier transform Fᵣᵣ is executed. Power spectrum |E|² of the above reference wave Sᵣ is thereby got.

At the same time, a square of Fourier transform Fᵣₛ of a cross-correlation Iᵣₛ between a reference wave Sᵣ and a measurement wave Sₛ is obtained.

Based on power spectrum |Eᵣ|² of the reference wave Sᵣ and Fourier transform Fᵣₛ of cross-correlation Iᵣₛ, at least one of electric field spectrum Eₛ (ω), power spectrum |Eₛ(ω)|², amplitude spectrum As and phase spectrum φₛ are obtained.

Herein, power spectrum |Eₛ|² is represented by next expression.

|Eₛ|²=(Fourier transform Fᵣₛ of cross-correlation Iᵣₛ)₂/(Fourier transform Fᵣᵣ of autocorrelation Iᵣᵣ of the reference wave Sᵣ)

Subject matter of a first mode of the object measurement device of the present invention includes (3) and (4).

(3) An object measurement device comprising a property identification device,

wherein the property identification device has a facility of the spectrum measurement device described in (1),

the reference wave path and the measurement wave path have the same start point,

the measurement wave path is formed to be turned back on surface or inside of a measurement object, or to penetrate the measurement object,

the property identification device derives property information (for example, at least one of space information, energy structural information, refractive index, transmission factor and reflectance) of the measurement device based on spectrum of the measurement wave.

(4) An object measurement device according to (3),

wherein the reference wave has a characteristic that delay time or advance time changes gradually along a virtual line which is perpendicular to a propagation direction,

or, the reference wave has a characteristic that delay time or advance time changes gradually along a virtual line on a virtual XY plane which is perpendicular to a propagation direction.

For example, the object measurement device comprises the property identification device with a facility of the spectrum measurement device. In the object measurement device, a reference wave path and a measurement wave path start from the same light source. The measurement wave path is formed to be turned back on surface or inside of a measurement object, or to penetrate the measurement object.

The property identification device derives property information (for example, at least one of space information, energy structural information, refractive index, transmission factor and reflectance) of the measurement device based on spectrum of the measurement wave.

In this object measurement device, a total reflection mirror can be set at a position of a measurement object, and a reference path is turned back with this total reflection mirror.

Subject matter of a second mode of a spectrum measurement device of the present invention includes (5).

(5) A spectrum measurement device receives reference wave propagating in a reference path, and receives measurement wave propagating in a measurement path having a start point same as a start point of the reference path, derives spectrum of the measurement wave,

wherein a spectrum of the reference wave is derived,

at the same time, Fourier transform of cross-correlation between the reference wave and the measurement wave is got,

the spectrum of the measurement wave is got based on the spectrum of the reference wave and the Fourier transform of the cross-correlation.

Specifically, electric field spectrum Eₛ(ω) is represented as complex conjugate of electric field spectrum Eₛ(ω) of a measurement wave Sₛ.

Eₛ*=[Fourier transform Fᵣₛ of cross-correlation Iᵣₛ]/[electric field spectrum of the reference wave Sᵣ]

Es* is complex conjugate of Eₛ.

Subject matter of a second mode of an object measurement device of the present invention includes (6) and (7).

(6) An object measurement device comprising a property identification device,

wherein the property identification device has facility of the spectrum measurement device described in (5),

a reference wave path and the measurement wave path have the same start point,

the measurement wave path is formed to be turned back on surface or inside of a measurement object, or to penetrate the measurement object,

the property identification device derives property information (for example, at least one of space information, energy structural information, refractive index, transmission factor and reflectance) of the measurement device based on spectrum of the measurement wave.

(7)

An object measurement device according to (6),

wherein the reference wave has a characteristic that delay time or advance time changes gradually along a virtual line which is perpendicular to a propagation direction,

or, the reference wave has a characteristic that delay time or advance time changes gradually along a virtual line on a virtual XY plane which is perpendicular to a propagation direction.

Subject matter of a third mode of an object measurement device of the present invention includes (8) and (9).

(8)

A spectrum measurement device which receives

a reference wave propagating in a reference path and

a first measurement wave, a second measurement wave, . . . , a N-th measurement wave propagating in a first measurement paths, a second measurement paths, . . . , a N-th measurement paths having a start point same as a start point of the reference path, and derives spectra of the first, the second, . . . , the N-th measurement wave,

wherein the spectra are

spectra of the first measurement wave, the second measurement wave, . . . , the N-th measurement wave which are turned back on surface or inside of a measurement object, or

spectra of the first measurement wave, the second measurement wave, . . . , the N-th measurement wave which penetrate the measurement object;

spectra of the first measurement wave, the second measurement wave, . . . , the N-th measurement wave are measured based on spectra of the reference wave and signals being proportional to square of each synthesized wave of the reference wave and the 1st, the 2nd, . . . , the N-th measurement wave.

(9) The spectrum measurement device according to (8),

wherein each spectrum of the first measurement wave, the second measurement wave, . . . , the N-th measurement wave is power spectrum,

the power spectrum of the k-th measurement wave (k: 1, 2, . . . or N) is represented by next expression.

[a spectrum provided by executing Fourier transform of signal proportionate to square of an synthesized wave of a reference wave and a k-th measurement wave]²/[a spectrum of a reference wave]

For example, the spectrum measurement device receives the reference Sᵣ wave propagating in a reference wave path and the 1st, the 2nd, . . . , the N-th measurement waves Sₛ₁, Sₛ₂, . . . , S_{sN} propagating in the 1st, the 2nd, . . . , the N-th measurement wave path having a start point same as a start point of the reference path.

And the spectrum measurement device can measure electric field spectra Eₛ(ω) of the 1st, the 2nd, . . . , the N-th measurement waves Sₛ₁, Sₛ₂, . . . , S_{sN}.

In this case, the spectrum measurement can measure at least one of electric field spectra Eₛ₁(ω), Eₛ₂(ω), . . . , E_{sN}(ω) of the 1st, the 2nd, . . . , the N-th measurement waves Sₛ₁, S_{S2}, . . . , S_{sN}, power spectrum |Eₛ₁(ω)|², |Eₛ₂(ω)|², . . . , |E_{sN}(ω)|², amplitude spectra Aₛ₁(ω), Aₛ₂(ω), . . . , A_{sN}(ω), phase spectra φₛ₁(ω), φₛ₂(ω), . . . , φ_{sN}(ω).

The spectrum measurement device can obtain the power spectrum |Eᵣ|² by executing Fourier transform about an autocorrelation Iᵣᵣ of the reference wave Sᵣ and can obtain squares of Fourier transforms Fᵣₛ₁, Fᵣₛ₂, . . . , F_{rsN} of a cross-correlations Iᵣₛ₁, Iᵣₛ₂, . . . , I_{rsN} between a reference wave Sᵣ and the 1st, the 2nd, . . . , the N-th measurement waves Sₛ₁, Sₛ₂, . . . , S_{sN}.

At least one of the spectra are measured based on the power spectrum |Eᵣ|² of the reference wave Sᵣ and squares of Fourier transforms Fᵣₛ₁, Fᵣₛ₂, . . . , F_{rsN} of a cross-correlations Iᵣₛ₁, Iᵣₛ₂, . . . , I_{rsN}.

Subject matter of a second mode of an object measurement device of the present invention includes (10) and (11).

(10) An object measurement device comprising a property identification device,

wherein the property identification device has facility of the spectrum measurement device described in (9),

the reference wave path and a first measurement wave path, a second measurement wave path, . . . , the N-th wave path have the same start point,

the first measurement wave path, the second measurement wave path, . . . , the N-th measurement wave path are formed to be turned back on surface or inside of a measurement object, or to penetrate the measurement object,

the property identification device derives property information of the measurement device based on spectra of a first measurement wave, a second measurement wave, . . . , a N-th measurement wave.

(11) Object measurement device according to (10),

wherein the reference wave has a characteristic that delay time or advance time changes gradually along a virtual line which is perpendicular to a propagation direction,

or, the reference wave has a characteristic that delay time or advance time changes gradually along a virtual line on a virtual XY plane which is perpendicular to a propagation direction.

The object measurement device comprising a property identification device with a facility of the spectrum measurement device. The reference wave path and a first measurement wave path, a second measurement wave path, . . . , the N-th wave path have the same start point. The first measurement wave path, the second measurement wave path, . . . , the N-th measurement wave path are formed to be turned back on surface or inside of a measurement object, or to penetrate the measurement object.

The property identification device derives property information (for example, at least one of space information, energy structural information, refractive index, transmission factor and reflectance) of the measurement device based on electric field spectrum Eₛ₁(ω), Eₛ₂(ω), . . . , E_{sN}(ω) of the first measurement waves, the second measurement waves, . . . , the N-th measurement waves Sₛ₁, Sₛ₂, . . . , S_{sN}.

Subject matter of a fourth mode of an object measurement device of the present invention includes (12).

(12) A spectrum measurement device which receives a reference wave propagating in a reference path and a first measurement wave, a first measurement waves, a second measurement wave, . . . , a N-th measurement wave propagating in a first measurement path, a second measurement path, . . . , a N-th measurement path having respectively a start point same as a start point of the reference path, and derives electric field spectra of the first measurement wave, the second measurement wave, . . . N-th measurement wave,

wherein Fourier transform of the cross-correlation between the reference wave and the first measurement wave, the second measurement wave, . . . , the N-th is respectively derived, and the electric field spectra are measured based on the spectra of the reference wave and Fourier transform of the cross-correlation.

Subject matter of a fourth mode of an object measurement device of the present invention includes (13) and (14).

(13) An object measurement device comprising a property identification device,

wherein the property identification device has facility of the spectrum measurement device described in (12),

a reference wave path and a first measurement wave path, a second measurement wave path, . . . , a N-th measurement wave path have the same start point,

the first measurement wave path, the second measurement wave path, . . . , the N-th measurement wave path are formed to be turned back on surface or inside of a measurement object, or to penetrate the measurement object,

the property identification device derives property information of the measurement device based on spectrum of the first measurement wave, the second measurement wave path, . . . , the N-th measurement wave.

(14) An object measurement device according to (13),

wherein the reference wave has a characteristic that delay time or advance time changes gradually along a virtual line which is perpendicular to a propagation direction,

or, the reference wave has a characteristic that delay time or advance time changes gradually along a virtual line on a virtual XY plane which is perpendicular to a propagation direction.

The object measurement device comprises property identification device with a function of the spectrum measuring instrument.

The first measurement wave path, the second measurement wave path, . . . , the N-th measurement wave path start from the same source (light source), and the first measurement wave path, the second measurement wave path, . . . , the N-th measurement wave path are formed to turn back in the surface or the inside of the measurement object O, or penetrate through a measurement object O.

The property identification device can derive the property information (e.g., at least one of space information, energy structural information, refractive index, transmittance, reflective index) of the measurement object based on electric field spectra Eₛ₁(ω), Eₛ₂(ω), . . . , E_{sN} (ω) of the first measurement wave, the second measurement wave, . . . , the N-th measurement wave Sₛ₁, Sₛ₂, . . . , S_{sN}.

[The First Basic Mode]

A first basic mode supports the spectrum measurement device of above (1) or (2), and the object measurement device of above (3).

The first basic mode of the present invention is described according to FIG. 1 and FIG. 2. In this mode a reference wave Sᵣ and a measurement wave Sₛ describe are lights respectively.

Note that the present invention is applicable to X-rays, terahertz frequency wave, radio wave, millimeter wave other than light.

As shown in FIG. 1 and FIG. 2, an object measurement device 100 comprises a source (a light source 11), an interferometer 12 and a property identification device 13.

A light emitted from the light source 11 is typically a broadband light such as a white light.

The interferometer 12 includes a beam splitter 121, a reference mirror 122 and a reference mirror drive 123 in this mode.

A reference wave path PTHᵣ starts from the light source 11 and arrives at the reference mirror 122 through beam the splitter 121. The reference wave path PTHr turns back on the reference mirror 122 and further arrives at the property identification device 13 through the beam splitter 121.

As shown in FIG. 2, the measurement wave path PTHₛ starts from the light source 11 and arrives at a measurement object O through the beam splitter 121. The measurement wave path PTHₛ turns back at the measurement object O and further arrives at the property identification device 13 through the beam splitter 121.

The property identification device 13 includes a facility as a spectrum measurement device, and consists of a photo detector 131 and an arithmetic processing component 132.

The arithmetic processing component 132 calculates autocorrelation Iᵣᵣ of the reference wave Sᵣ and executes Fourier transform Fᵣᵣ of autocorrelation Iᵣᵣ.

Even more particularly, the arithmetic processing component 132 calculates cross-correlation Iᵣₛ between the reference wave Sᵣ and the measurement wave Sₛ. The arithmetic processing component 132 executes Fourier transform Fᵣₛ of cross-correlation Iᵣₛ.

At least one following characteristics are calculated by Fourier transform Fᵣᵣ and Fᵣₛ.

Electric field spectrum of measurement wave Sₛ: Eₛ(ω)

Power spectrum: |Eₛ(ω)|²

Amplitude spectrum: Aₛ(ω)

Phase spectrum: φₛ(ω)

As shown in FIG. 1, in a case autocorrelation Iᵣᵣ is necessary, a total reflection mirror 124 is provided at the position of the measurement object O.

The arithmetic processing component 132 comprises an arithmetic unit 1321 and previously described a memory 1322.

The arithmetic unit 1321 calculates autocorrelation Iᵣᵣ and calculates Fourier Fᵣᵣ transform. Fourier transform Fᵣᵣ is stored to the memory 1322.

On the other hand, on occasion of measurement of the measurement object O, the photo detector 131 receives the reference wave Sᵣ and the measurement wave Ss reflected at the measurement object O through the beam splitter 121 as shown in FIG. 2.

The arithmetic unit 1321 receives an interference wave that the photo detector 131 detected as an electrical signal, the arithmetic unit 1321 accounts cross-correlation Iᵣₛ from the reference wave Sᵣ and the measurement wave Sₛ, and the arithmetic unit 1321 calculates Fourier transform Fᵣₘ.

The arithmetic unit 1321 can calculate power spectrum |Eₛ|² of a measurement wave Ss like next expression based on Fourier transform Fᵣᵣ of autocorrelation Iᵣᵣ stored in the memory 1322 and Fourier transform Fᵣₛ of and cross-correlation Iᵣₛ.

|Eₛ|²=(Fourier transform Fᵣₛ of cross-correlation Iᵣₛ)²/(Fourier transform Fᵣᵣ of autocorrelation Iᵣᵣ of the reference wave Sᵣ)

Also, the arithmetic processing component 132 can calculate at least of some information about the measurement object O based on power spectrum |Eₛ|² of the measurement wave Ss measured. The information are space information, energy structural information, refractive index, transmittance and reflective index.

[The Second Basic Mode]

A second basic mode supports the spectrum measurement device of above (5), and the object measurement device of above (6).

The second basic mode of the present invention is described according to FIG. 3 and FIG. 4 for an example. In this mode the reference wave Sᵣ and the measurement wave Sₛ describe are lights respectively.

As shown in FIG. 3 and FIG. 4, a object measurement device 200 comprises a source (a light source 21), an interferometer 22 and a property identification device 23.

A light emitted from the light source 21 is typically a broadband light such as a white light.

The interferometer 22 includes a beam splitter 221, a reference mirror 222 and a reference mirror drive 223 in this mode.

The reference wave path PTHᵣ starts from the light source 21 and arrives at the reference mirror 222 through the beam splitter 221 and turns back the reference mirror 222 and further arrives at the property identification device 23 through the beam splitter 221.

As shown in FIG. 4, the measurement wave path PTHₛ starts from the light source 21 and arrives at the measuring object O through the beam splitter 221. And the measurement wave path PTHₛ turns back at the measurement object O and further arrives at the property identification device 23 through the beam splitter 221.

The property identification device 23 includes a facility as the spectrum measurement device, and consists of a photo detector 231, an arithmetic processing part 232, an electric field spectrum measurement part 233 and a beam splitter 234.

An electric field spectrum Eᵣ(ω) of the reference wave Sᵣ is calculated based on the electric field spectrum measurement part 233.

The electric field spectrum measurement part 233 has an auxiliary signal part 2331, a relative phase detecting part 2332, an amplitude detecting part 2333 and a frequency selectivity part 2334.

The photo detector 231 detects only a reference wave Sᵣ to measure the electric field spectrum Eᵣ(ω).

(for example, the reflected wave from the measurement object O does not arrive at the photo detector 231)

To achieve above, for example, the position of the measurement object O is provided with a light absorption board 224 as shown in FIG. 3.

The auxiliary signal generation part 2331 is constructed, for example, by a two wave length mode-locking broad band laser.

An auxiliary signal generation part 2331 generates two auxiliary signals uₐₘ, uₐₙ.

The frequency middle level of two auxiliary signals uₐₘ, uₐₙ is set between the frequency of two reference wave components sᵣₘ, sᵣₙ (frequency interval Δω).

The frequency interval of two auxiliary signals uₐₘ, uₐₙ is the same as the frequency interval of two reference wave components sᵣₘ, sᵣₙ.

The relative phase detecting part 2332 generates a beat signal BTₘ (not shown) of a reference wave component sᵣₘ that frequency is low and an auxiliary signal uₐₘ, and the relative phase detecting part 2332 generates a beat signal BTₙ (not shown) of a reference wave component sᵣₘ that frequency is high and an auxiliary signal uₐₘ.

The relative phase detecting part 2332 generates multiplication signal of these two beat signals BTₘ and BTₙ.

A constant to be decided by detection system is removed from DC component of the multiplication signal.

Relative phase φᵣₙ-φᵣₘ of the reference wave components sᵣₘ and sᵣₙ is thereby detected.

Also, the magnitude detecting part 2333 can measure magnitude Aᵣₘ of the reference wave component sᵣₘ from the beat signal BTₘ (not shown) of the auxiliary signal uₐₘ and the reference wave component sᵣₘ, and the magnitude detecting part 2333 can measure the magnitude Aᵣₙ of the reference wave component sᵣₙ from the beat signal BTₙ (not shown) of the auxiliary signal uₐₘ and the reference wave component sᵣₙ.

The electric field spectrum measurement part 233 executes the process about a pair of a lot of the reference wave components sᵣₙ that frequency is different each other. The electric field spectrums Eᵣ(ω) of the reference wave Sᵣ is measured as mentioned above.

This electric field spectrums Eᵣ(ω) is stored in a memory 2322 of the arithmetic processing part 232.

On the other hand, in measurement of the measurement object O, the photo detector 231 receives a reference wave Sᵣ and a measurement wave Sₛ reflected from the measurement object O through the beam splitter 221 as shown in FIG. 4 (an interference wave).

The arithmetic processing component 232 comprises an arithmetic unit 2321 and the memory 2322.

The arithmetic unit 2321 includes facility to operate arithmetic of the cross-correlation.

The arithmetic unit 2321 receives an interference wave that the photo detector 231 detected as electrical signal.

The arithmetic unit 2321 calculates cross-correlation Iᵣₛ from the reference wave Sᵣ and the measurement wave Sₛ.

The arithmetic unit 2321 executes Fourier transform Fᵣₛ of cross-correlation Iᵣₛ (it assumes Fourier transform).

The arithmetic unit 2321 can calculate electric field spectrum Eₛ of the measurement wave Sₛ based on electric field spectrum Eᵣ(ω), and Fourier transform Fᵣₛ is memorized in the memory 2322.

The complex conjugate Eₛ* of the electric field spectrum Eₛ(ω) of measurement wave Ss is represented by next expression.

Eₛ*=(Fourier transform Fᵣₛ of cross-correlation Iᵣₛ)/(electric field spectrum of reference wave Sᵣ)

The arithmetic processing component 232 can calculate at least one of some information of the measurement object O based on electric field spectrum Eₛ(ω) of measurement wave Sₛ.

These information are space information, energy structural information, refractive index, transmission factor and reflectance.

Note that, in sampling, it is necessary to sample by the time when it is shorter than time of λ/2c according to “sampling theorem”.

The sampling is executed according to “sampling theorem” in time that is shorter than λ/2c.

[The Third Basic Mode]

A third basic mode supports the object measurement device of above (4) and (7).

According to the present invention, it is possible so that (or it advances time) has a characteristic to change in coarseness along the virtual line where the reference wave Sᵣ is perpendicular to the propagation direction in delay time.

Delay time of the reference wave Sᵣ gradually changes along virtual line which is perpendicular to propagation direction.

FIG. 5 (A), (B) are figures of image of time lag.

FIG. 5 (A) is a figure showing the reference wave Sᵣ before time lag occurs, and FIG. 5 (B) is a figure showing the reference wave Sᵣ after time lag produced.

In FIG. 5 (B), delay time Δₜ gradually changes along virtual line g which is perpendicular to propagation direction.

In this case, a property of depth direction at a point of the measurement object O is provided.

The photo detectors 131,231 are sensors comprising picture elements arranged in a single dimension.

Each of picture elements of the sensor detects light with information (cΔₜ) corresponding to depth of the measurement object O.

Also, in the present invention, the delay time (or progress time) of the component along the X-direction of the virtual XY plane may gradually change.

The virtual XY plane is perpendicular to propagation direction of the reference wave Sᵣ wherein.

FIG. 6 (A), (B) are figures of image of time lag.

FIG. 6 (A) is a figure showing the reference wave Sᵣ before time lag occurs, and FIG. 6 (B) is a figure showing the reference wave Sᵣ after time lag occurs.

In FIG. 6 (B), delay time Δₜ gradually changes along virtual plane G which is perpendicular to propagation direction.

In this case, a property of depth direction of cut line of the measurement object O is provided.

The photo detectors 131,231 are sensors comprising picture elements arranged in two dimensions.

A picture elements group of the X-direction of the sensor detects light with information (cΔₜ) corresponding to depth of the measurement object O in points corresponding to Y coordinate.

[Application Mode]

According to the present invention, the basic mode can be expanded.

That is, about the measurement object O of N layer, at least one of some information are measured.

These information are electric field spectrum Eₛ (ω), power spectrum |Eₛ (ω)|², amplitude spectrum Aₛ (ω), phase spectrum φₛ(ω).

This applied mode supports the spectrum measurement device of above (8), (9), (12) and the object measurement device of (10) (11), (13), (14).

Explanation about these is described below.

### EFFECT OF THE INVENTION

In the measurement of the measurement object having heterogeneous internal structure,

when a general-purpose spectrum measurement device is used, spectrum information that complicated optical spectrum information is observed.

On the other hand, in a technique of the present invention, some property information depending on depth of the measurement object are measured with high resolution of several microns at the same time.

For example, these property information are space information, energy structural information, an refractive index, a transmission factor, reflectance.

Particularly, with the present invention, two-dimensional coaxial tomography is measured at frame rate of an image sensor.

Therefore, a tomogram measurement and a detection of optical spectrum information can be executed by real time.

In medical applications, a light coherence tomography is already put to practical use.

In the light coherence tomography, there is derived to measure a structure of internal organization by non-contact/non-aggression by light.

Inspection device to perform a tomogram measurement is already put to practical use, for funduscopy in part of ophthalmology, skin cancer inspection in department of dermatology, and inspection of the disease of the digestive system including stomach cancer in internal department.

However, expert experience and knowledge are necessary to determine diseases such as cancer from a shape.

According to the present invention, it can obtain spectrum information every system.

For example, the distinction of the cancer tissue can be executed objectively.

According to the present invention, multi-path reflection is performed in the reference side.

Measurement is thereby possible even if the measurement object is a long distance (e.g., dozens of meters) away from the measurement device.

### BRIEF DESCRIPTION OF DRAWINGS

FIG. 1 is a configuration diagram of first basic mode of the present invention. FIG. 1 shows a state to measure autocorrelation of reference wave.

FIG. 2 is configuration diagram of the first basic mode of the present invention.

FIG. 2 shows reference wave and cross-correlation with the measurement wave, and shows the state that various spectra of measurement wave and property of a measurement object are measured.

FIG. 3 is a configuration diagram of second basic mode of the present invention, and FIG. 3 shows a state to measure the electric field spectrum of reference wave.

FIG. 4 is a configuration diagram of second basic mode of the present invention.

FIG. 4 shows a reference wave and the cross-correlation with the measurement wave.

FIG. 4 shows a state to measure property of various spectra of measurement wave and a measurement object.

FIG. 5 is image explanatory drawing.

When property of a measurement object is measured about point depth, state that reference wave delays is shown.

FIG. 5 (A) shows a reference wave before time lag occurs.

FIG. 5 (B) shows a reference wave after time lag occurred.

FIG. 6 is image explanatory drawing.

When property of a measurement object is measured about line depth, state that reference wave delays is shown.

FIG. 6 (A) shows a reference wave before time lag occurs.

FIG. 6 (B) shows a reference wave after time lag occurred.

FIG. 7 is configuration diagram of first embodiment of the present invention.

FIG. 7 is a figure showing states to measure the autocorrelation of reference wave, and a total reflection mirror is set at the position of the measurement object.

FIG. 8 is a configuration diagram of first embodiment of the present invention, and a measurement object has two boundary surfaces.

By measurement device of FIG. 8, cross-correlation of reference wave and measurement wave is measured.

By measurement device of FIG. 8, various spectra of measurement wave and property of a measurement object are measured.

FIG. 9 is a configuration diagram of first embodiment of the present invention, and a measurement object has a plurality of borders surfaces.

By measurement device of FIG. 9, cross-correlation of reference wave and measurement wave is measured.

By measurement device of FIG. 9, various spectra of measurement wave and property of a measurement object are measured.

FIG. 10 is a figure showing first constitutional example of second embodiment of the present invention.

FIG. 10 shows an embodiment of an object measurement device of FIGS. 3 and 4.

FIG. 11 is figure showing relative phase detecting part and magnitude detecting part in first constitutional example of FIG. 10.

FIG. 12 is a figure showing second constitutional example of second embodiment of the present invention.

FIG. 12 shows an embodiment of an object measurement device of FIGS. 3 and 4.

FIG. 13 is figure showing relative phase detecting part and magnitude detecting part in second constitutional example of FIG. 12.

FIG. 14 is a figure showing relations of frequency of auxiliary signal and frequency of reference wave component in second embodiment of the present invention.

FIG. 15 is figure showing relationships between normalized DC and relative phase in second embodiment of the present invention.

FIG. 16 is explanatory drawing showing the methods to determine “true relative phase” from two normalized DC components in second embodiment of the present invention.

FIG. 17 is explanatory drawing of first constitutional example (a Mach-Zehnder type) of an interferometer used in the present invention.

FIG. 18 is a figure showing a modulator used in an interferometer shown in FIG. 17.

FIG. 19 is explanatory drawing of second constitutional example (a Mach-Zehnder type) of an interferometer used in the present invention.

FIG. 20 is a figure showing a modulator used in an interferometer shown in FIG. 19.

FIG. 21 is explanatory drawing of third constitutional example (a Mach-Zehnder type) of an interferometer used in the present invention.

FIG. 22 is explanatory drawing of fourth constitutional example (a Mach-Zehnder type) of an interferometer used in the present invention.

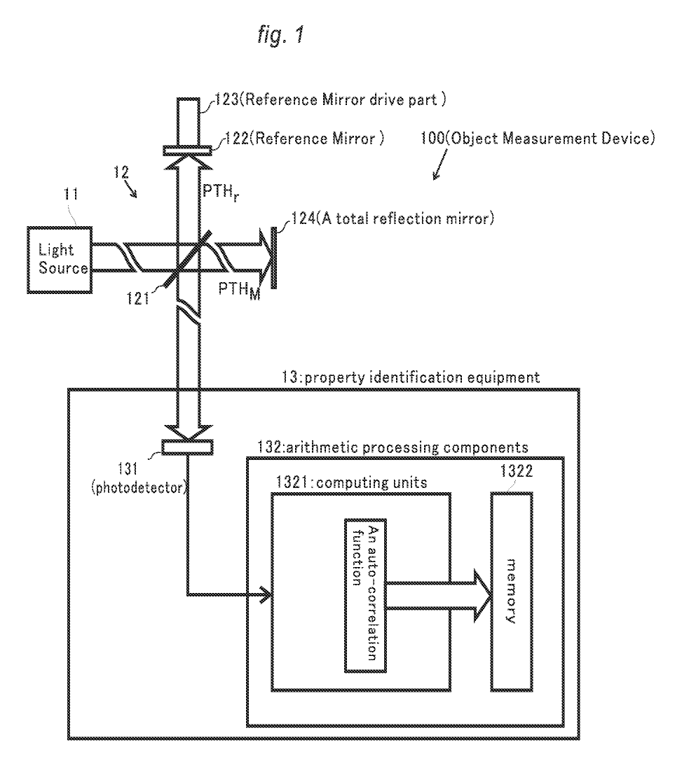

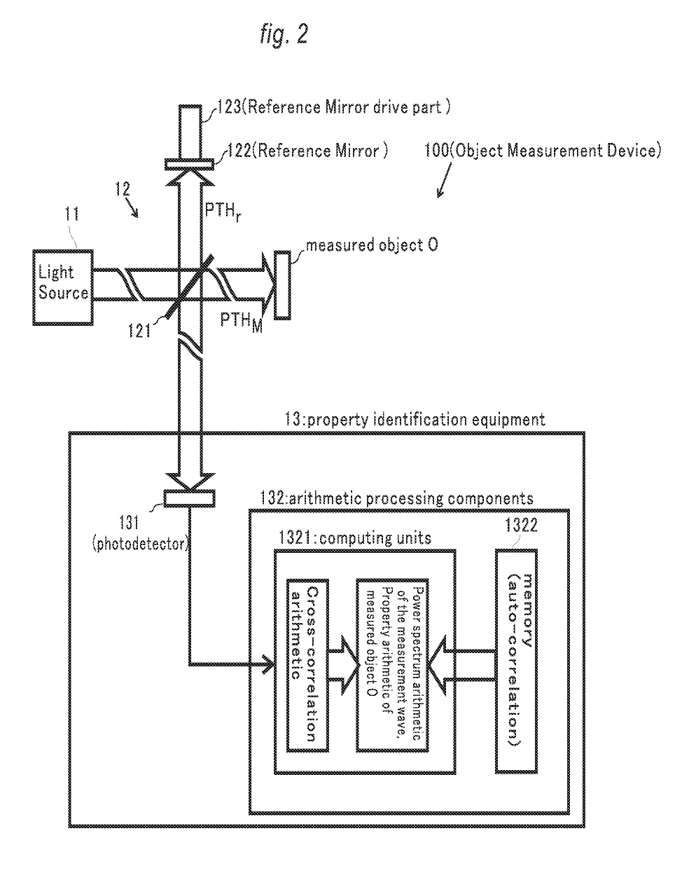

### DESCRIPTION OF THE PREFERRED EMBODIMENT

Embodiments of the present invention are described below.

Note that, in the present embodiment, “light” is used as “a wave”.

“The source” in the present invention is replaced with “a light source”.

### First Embodiment

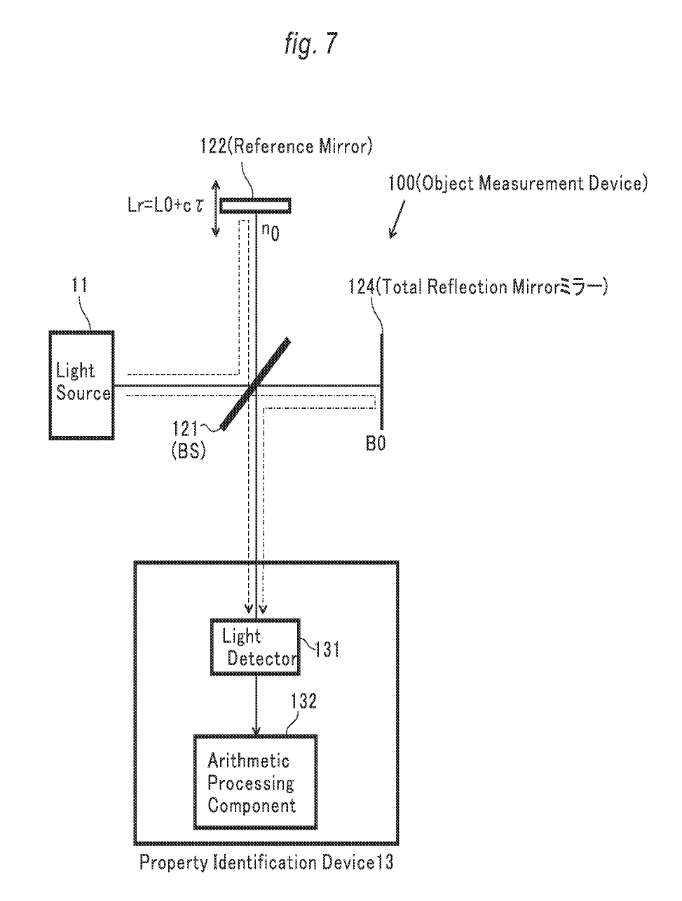

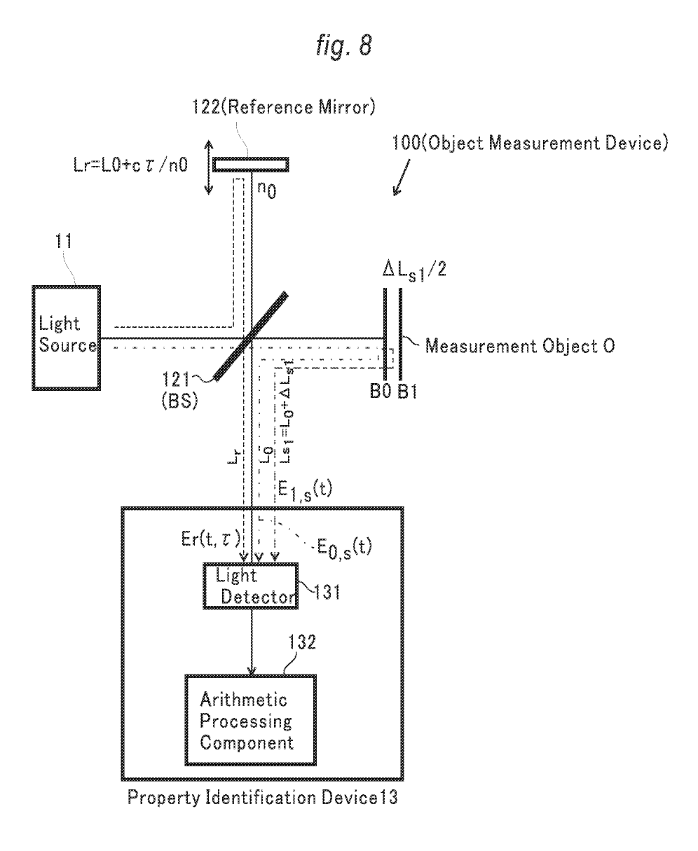

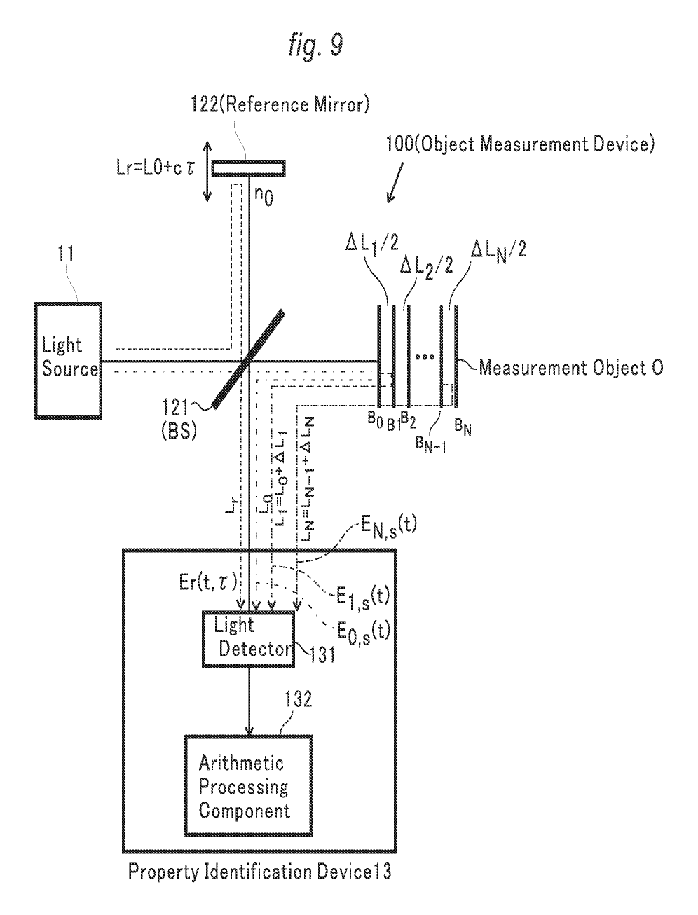

A first embodiment of the object measurement device 100 of the present invention is explained by FIG. 7, FIGS. 8 and 9.

In this embodiment, power spectrum, phase or others are measured based on autocorrelation of the reference wave Sᵣ and cross-correlation of a reference wave Sᵣ and a measurement wave Sₛ.

Even more particularly, space information, energy structural information, refractive index, transmission factor, reflectance or others of a measurement object are acquired.

[1] Autocorrelation is derived by setting a total reflection mirror in a measurement object position. By executing Fourier transform of autocorrelation, a power spectrum of the measurement light is derived.

[2] The measurement object O is set in a measurement object position. Acquired cross-correlation is executed Fourier transform.

[3] Based on Fourier transform of autocorrelation and Fourier transform of cross-correlation, power spectrum of the measurement object, phase or others are derived.

Some information are measured.

[1] Deriving of Autocorrelation, Execution of the Fourier Transform of the Autocorrelation, and Deriving of Power Spectrum of Reference Light

As shown in FIG. 7, the total reflection mirror 124 is installed in the measurement object position.

Interference light (autocorrelation Iᵣᵣ (t)) is measured.

A power spectrum of the reference wave Sᵣ is got by Fourier transform of autocorrelation Iᵣᵣ (t).

(A)

Fourier transform of autocorrelation of a reference light is an electric field spectrum.

This is proved below.

In an interferometer 12, Fourier transform of the autocorrelation is a power spectrum of a light source 11.

This is inspected below.

It supposes a power spectrum of the light source 11 to be |A(ω)|² (it may write down with A(ω)² as follows)

The electric field Eᵣ (t, τ) of the reference wave Sᵣ output from the interferometer 12 is represented by expression (1).

Eᵣ(t,τ)=[A(ω)/₂^{1/2}]exp[j{ωt−(n₀ωLᵣ/c)}] (1)

n₀: reference path

PTHᵣ: an refractive index in measurement path PTHₛ

c: light velocity

Lᵣ: an optical path length (a path length of reference wave path PTHᵣ) of the reference wave Sᵣ

τ: Time displacement when position of a reference mirror changed

On the other hand, reflect light (measurement wave Sₛ) from the total reflection mirror 124 is output from the interferometer 12.

Electric field Eₘᵢᵣᵣ (t) of measurement wave Sₛ is represented by an expression (2).

Eₘᵢᵣᵣ(t)=[A(ω)/2^{1/2}]exp[j{ωt−(n₀ωLₛ/c}] (2)

Lₛ: optical path length of measurement wave Sₛ (optical path length of measurement wave path PTHₛ)

Electric field Eᵣ(t, τ) of reference wave Sᵣ

Electric field Eₘᵢᵣᵣ(t) of measurement wave Sₘᵢᵣᵣ

Interference output Iᵣᵣ (t) of Eᵣ (t, τ) and Eₘᵢᵣᵣ(t) is referred to by an expression (3).

Iᵣᵣ(t)=A(ω)²+A(ω)²exp[j{[−(n₀ω/c)(Lᵣ−Lₛ)}]=A(ω)²+A(ω)²exp(jωτ) (3)

Iᵣᵣ(t) is a sine (or cosine) wave. And Fourier transform of this change component is represented by an expression (4).

A(ω)A(ω)*=A(ω)² (4)

A(ω)*: complex conjugate of A(ω)

A(ω) meets Wiener Khinchin theorem. That is, interference light gives autocorrelation Iᵣᵣ (t).

Electric field spectrum Eᵣᵣ (ω) is provided from Fourier transform F[Iᵣᵣ(t)] of Iᵣᵣ (t) as shown by expression (5).

Eᵣᵣ(ω)=F[Iᵣᵣ(t)] (5)

(B)

In this embodiment, at first interference light (autocorrelation Iᵣᵣ(t)) is measured.

Then, Fourier transform of Iᵣᵣ(t) is demanded.

Fourier transform of Iᵣᵣ(t) is power spectrum of the reference wave Sᵣ so that it was proved in (A).

[2] The Acquisition of the Cross-Correlation, Fourier Transform of the Cross-Correlation and Acquisition of Electric Field Spectrum of Measurement Light

As shown in FIG. 8, the measurement object O is set at the position of the total reflection mirror 124 of FIG. 7.

As shown in FIG. 8, the reference mirror 122 of the interferometer 12 is scanned (delay time: τ).

Interference of reference wave Sᵣ and measurement light (reflect light) from the measurement object O is thereby measured.

The measurement object O has two boundary surface B₀, B₁ which are adjacent at intervals of ΔLₛ₁/2.

An optical path length (an optical path of first measurement path PTHₛ₁ to turn back in boundary surface B₀) of measurement wave Sₛ₁ from boundary surface B₀ is L₀.

The optical path length (a path length of second measurement path PTHₛ₂ to turn back in a boundary surface B₁) of the reflect light (measurement wave Sₛ₂) of the boundary surface B₁ is Lₛ₁ (=L₀+ΔLₛ₁).

On the other hand, the optical path of the reference wave Sᵣ is represented by the next expression as previously described.

Lᵣ=L₀+(c/n₀)τ

Also, space between boundary surface B₀ and B₁ is filled with a material of refractive index (a complex number) n₁(ω).

refractive index of space except the measurement object O is constant n₀ which does not almost depend on wave length like air.

Also, the amplitude reflectance in boundary surface B₀ and B₁ is represented in rₛ₀₊, rₛ₀₋, rₛ₁₊, respectively.

The amplitude transmittance in boundary surface B₀ and B₁ is represented in tₛ₀₊, tₛ₀₋, tₛ₁₊, respectively.

“+” represents an incident direction, and “−” represents a return direction wherein.

However, |rₛ₀₊|=<1, |rₛ₀₋=<1, 0=<tₛ₀₊=<1, 0=<tₛ₀₋=<1, |rₛ₁₊|=<1, 0=<tₛ₁₊=<1.

Electric field waveform of reference wave Sᵣ of this case is represented by expression (6) (it is the same with expression (1)).

Er(t,τ)=[A(ω)/2^{1/2}]exp[j{ωₜ−(n₀ωLᵣ/c)}])=[A(ω)/2^{1/2}]exp[j{ωₜ−(n₀ωL₀/c)+ω_{τ}}] (6)

On the other hand, electric field Eₛ₀(t) of the reflect light (measurement wave Sₛ1) from the measurement object O is represented by an expression (7).

On the other hand, electric field Eₛ₀(t) and Eₛ₁(t) of two reflect light (measurement wave Sₛ₁, Sₛ₂) from the measurement object O are represented by an expression (7) and an expression (8), respectively.

Eₛ₀(t)=[rₛ₀₊A(ω)/2^{1/2}]exp[j{ωt−(n₀ωL₀/c)}]) (7)

Eₛ₁(t)=[(tₛ₀₊tₛ₀₋rₛ₀₊)A(ω)/2^{1/2]}

exp[j{ωt−(n₀ωL₀/c)−(n₁(ω)ωΔLₛ₁/c)}]) (8)

When a low coherence the light source is used, Eₛ₀(t) and Eₛ₁(t) do not interfere if ΔLₛ₁ is longer than coherence length.

Thus two next interference is examined.

(A)

Interference of electric field Eᵣ(t, τ) of the reference wave Sᵣ and electric field Eₛ₀(t) of the reflect light (measurement wave Sₛ₁).

(B)

Interference of electric field Eᵣ(t, τ) of reference wave Sᵣ and electric field Eₛ₁(t) of reflect light (measurement wave Sₛ₂).

(A)

Examination of the Interference of Reference Wave Sᵣ and Measurement Wave Ss1

The reference wave Sᵣ which is detected with the photo detector 131 and reflected wave (measurement wave Sₛ₀) interference output Iᵣ₍ₛ₀₎ (τ) from boundary surface B₀ are represented by expression (9).

Iᵣ₍ₛ₀₎(τ)=A(ω)²/2+rₛ₀₊²A(ω)²/2+rₛ₀₊A(ω)² cos {−(n₀ω(L₀−Lᵣ)/c})

Lᵣ=L₀+cτ/n₀

An expression (9) is derived from above formulas.

I₀(τ)=A(ω)²/2+rₛ₀₊²A(ω)²/2+rₛ₀₊A(ω)² cos(ωτ) (9)

Expression (9) is sine wave, and magnitude is provided by Fourier transform of change component of expression (9). The magnitude is represented by an expression (10).

{|rₛ₀₊²A(ω)²}δ(ω)=|rₛ₀₊|A(ω)² (10)

Thus, an expression (11) is derived from an expression (10) and an expression (4).

F[I₀(τ)]²/F[Iᵣᵣ(τ)]={rₛ₀₊²A(ω)⁴}/A(ω)²=rₛ₀₊²A(ω)² (11)

The expression (11) is power spectrum of reflect light (measurement wave Sₛ₁) of boundary surface B₀.

The loss for the reflection coefficient is given to expression (11).

(B)

Examination of the Interference with Reference Wave Sᵣ and the Reflect Light (Measurement Wave Sₛ₂)

On the other hand, in this example, a case with absorption is assumed by a sample.

Complex refractive index nₛ₁ (ω) is represented by an expression (12).

In an expression (12), refractive index nₛ₁^{re} (ω) and absorption coefficient c/ω{nₛ₁^{im}(ω)} are used.

nₛ₁(ω)=nₛ₁^{re}(ω)+jc/ω{nₛ₁^{im}(ω)} (12)

In using expression (12), interference output Is of reference wave Sᵣ and reflect light (measurement wave Sₛ₂) from boundary surface B₁ is represented by expression (13).

Iᵣ₍ₛ₁₎(τ)=A(ω)²/2+(tₛ₀₊tₛ₀₋rₛ₁₊)²A(ω)²/2+(tₛ₀₊tₛ₀₋rₛ₁₊)²A(ω)²

cos {ωt−(n₀ωL₀/c)−(n₁(ω)ωΔLₛ₁/c)−(n₀ωLᵣ/c)}

The relational expression Lᵣ=L₀+cτ/n₀ and an expression (10) are used.

Iᵣ₍ₛ₁₎(τ) is represented by the next expression.

Iᵣ₍ₛ₁₎(τ)=A(ω)²/2+(tₛ₀₊tₛ₀₋rₛ₁₊)²A(ω)²/2+(tₛ₀₊tₛ₀₋rₛ₁₊)²A(ω)²[(tₛ₀₊tₛ₀₋rₛ₁₊)A(ω)²exp{−nₛ₁^{im}(ω)ΔLₛ₁}] cos(ω_{τ})*cos(−nₛ₁^{re}(ω)ΔLₛ₁/c) (13)

The change component of the expression (13) is executed Fourier transform, and magnitude As is got by an expression (14).

Also, phase φₛ is got by an expression (15).

Aₛ(ω)=[(tₛ₀₊tₛ₀₋rₛ₁₊)A(ω)²exp{−nₛ₁^{im}(ω)ΔL₁}] (14)

φs(ω)=−nₛ₁^{re}(ω)ΔLₛ₁/c (15)

The power spectrum of reflect light E₂ is got as expression (16).

F[Iₛ(τ)]²/F[Iᵣᵣ(τ)]=(tₛ₀₊tₛ₀₋rₛ₁₊)²A(ω)²exp{−2nₛ₁^{im}(ω)ΔLₛ₁} (16)

That is, the expression (16) means that original spectrum damps according to wavelength dependence of the absorption coefficient and thickness.

Even more particularly, magnitude A₁ (ω) of expression (14) is divided by power spectrum of the original light source, and logarithmic calculation is executed.

From the real part (expression (17)), extreme absorption spectrum proportional to distance is provided.

Also, from imaginary part (expression (18)), refractive index is provided.

nₛ₁^{re}(ω)=φₛ(ω)*c/(ωΔLₛ₁) (17)

nₛ₁^{im}(ω)=(1/ΔLₛ₁)logₑ [A₁(ω)/{(tₛ₀₊tₛ₀₋rₛ₁₊)A(ω)²}] (18)

Even more particularly, nₛ₁^{re}(ω) may resemble nₛ₁^{re}.

nₛ₁^{re} does not depend on the wave length.

In this case, group delay is provided.

That is, phase φ₁ (ω) of expression (13) is differentiated by ω.

And degree of leaning of phase spectrum is calculated.

dφ₁(ω)/dω=−nₛ₁^{re}ΔLₛ₁ (19)

The expression (19) shows that horizontal scale τ of the correlative waveform is displaced from a waveform provided from boundary surface B₀.

This means that a cross-correlation waveform is measured in absence of absorption by a sample.

In FIG. 9, the measurement object O comprises boundary surfaces (B₀, B₁, . . . , B_{N}) three or more.

Measurement of the measurement object O of FIG. 9 are described below.

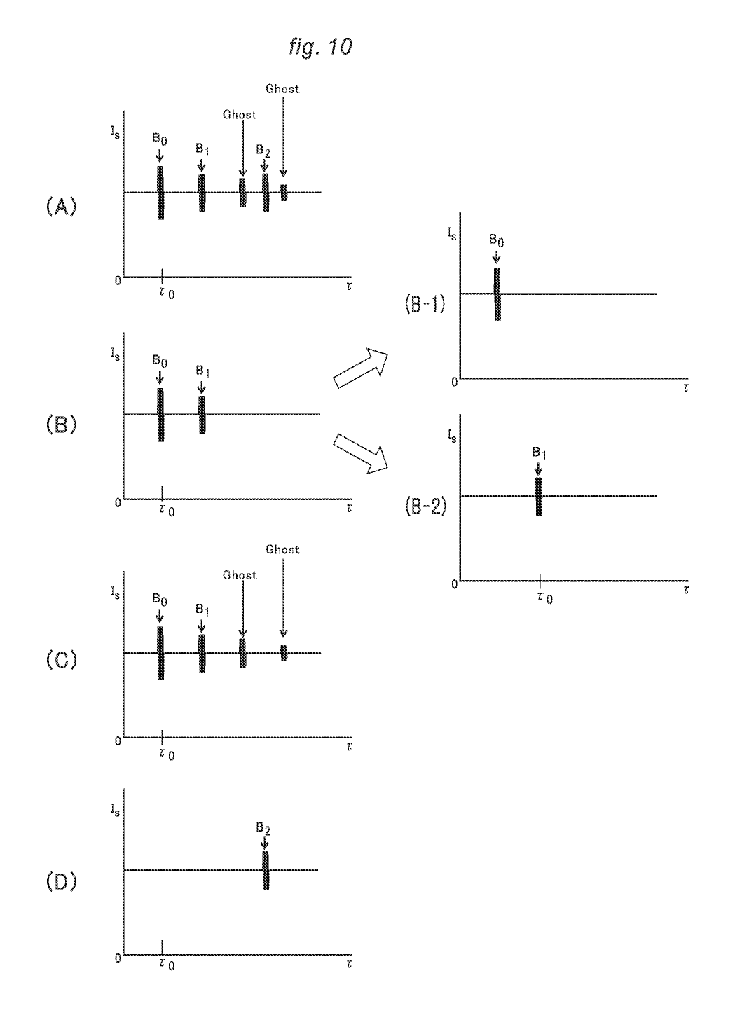

In this measurement, interference wave as shown in FIG. 10 (A) is measured.

At first in this case interference waveform (cf. position τ₀ in time base τ) reflected in boundary surface B₀ is determined as shown in FIG. 10 (B) (cf. (B−1)).

With this, an interference waveform reflected in boundary surface B₁ is determined (cf. (B−2)).

Then, as shown in FIG. 10 (C), a ghost (for example, a plurality of interference waveforms) by the multiple reflection to produce between boundary surfaces B₀ and B₁ is estimated (it is acquired or it is assigned) based on these interference waveforms.

Then, as shown in FIG. 10 (D), a reflected wave that was reflected back in boundary surfaces B₀ and B₁ and a ghost by the multiple reflection which occurred between boundary surface B₀ and B₁ are removed by an interference waveform detected by arithmetic.

Interference waveform which is nearest to τ₀ is estimated (acquired or assigned) as follows by the rejection result.

This interference waveform is reflected wave from boundary surface B₃ and an interference waveform reflected once.

Like the above, interference waveform from boundary surface B₃, B₄, B₅, . . . , B_{N} is estimated.

### Second Embodiment

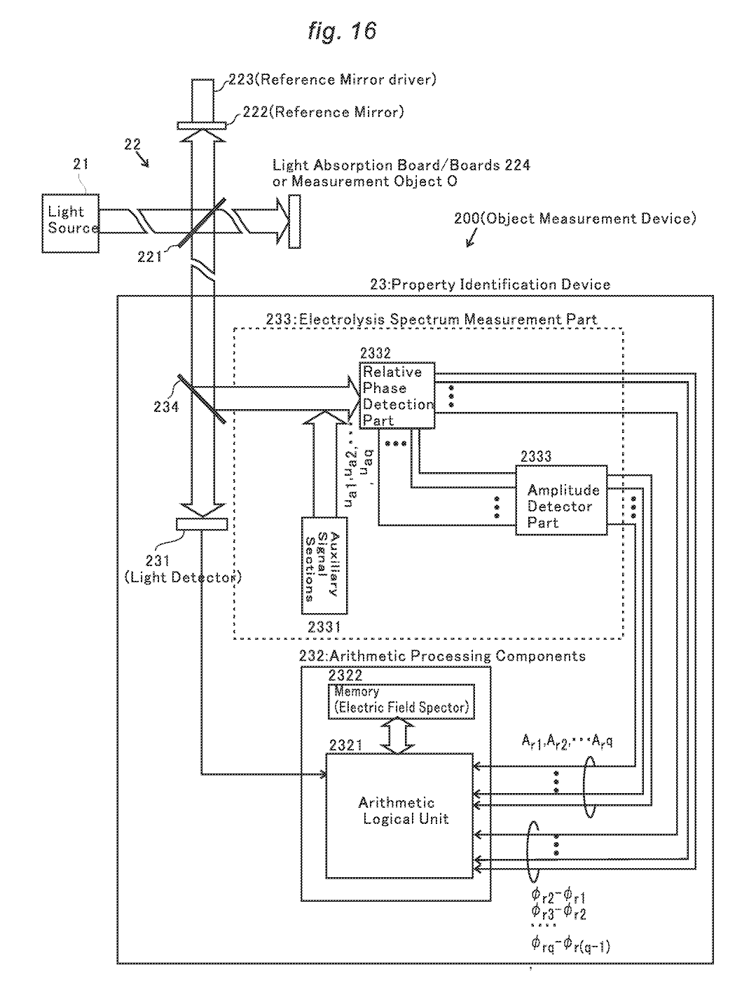

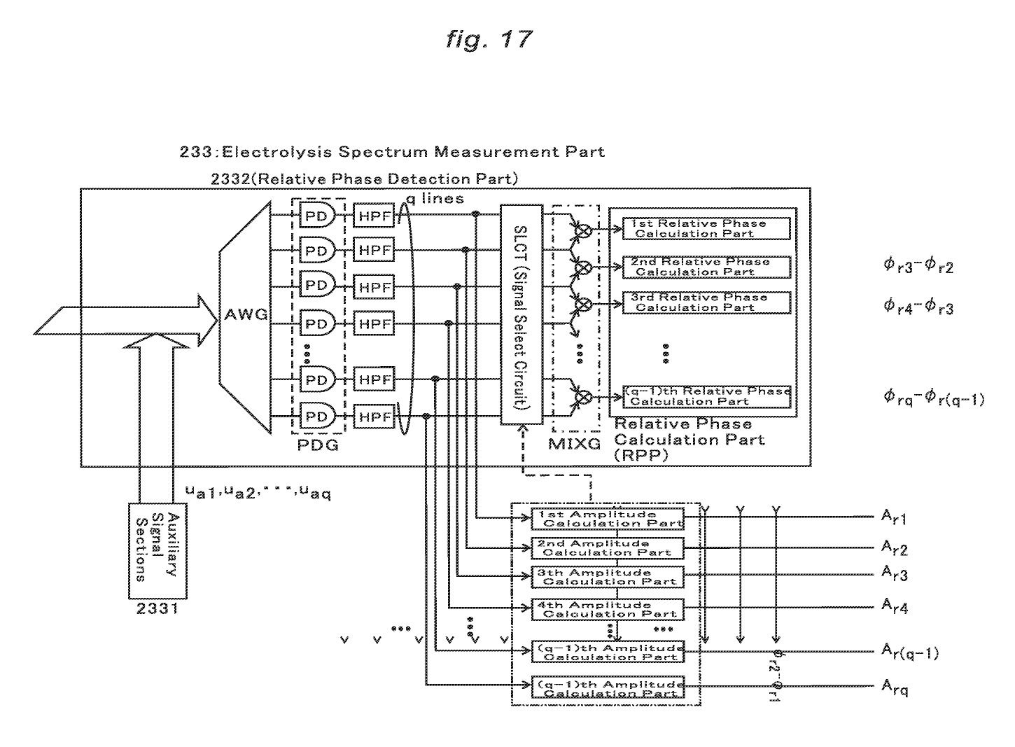

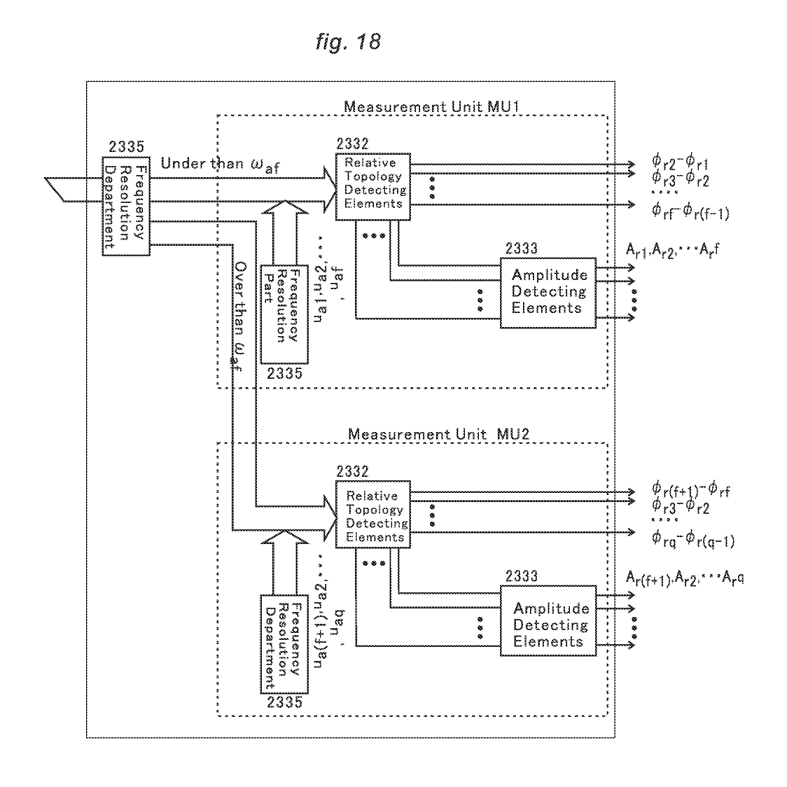

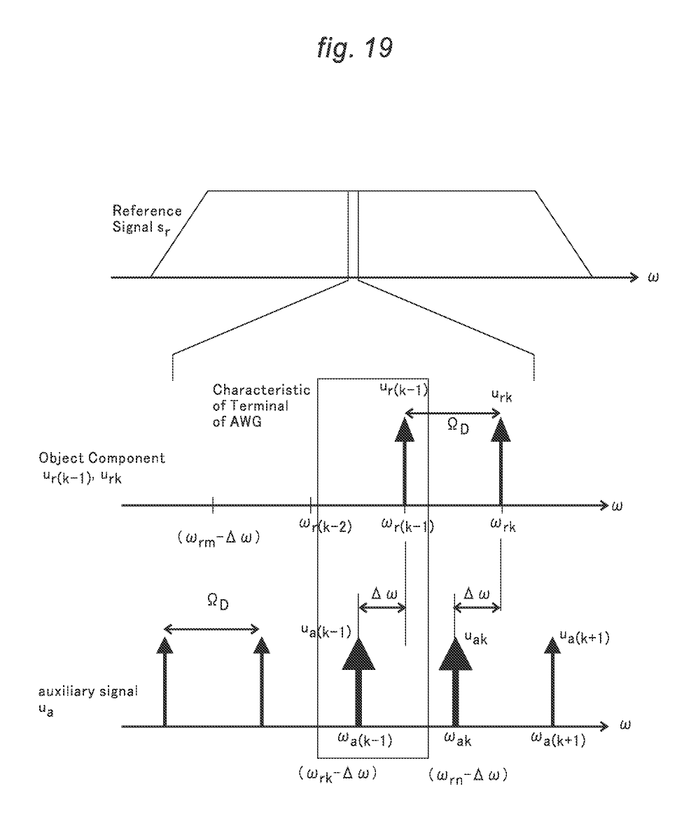

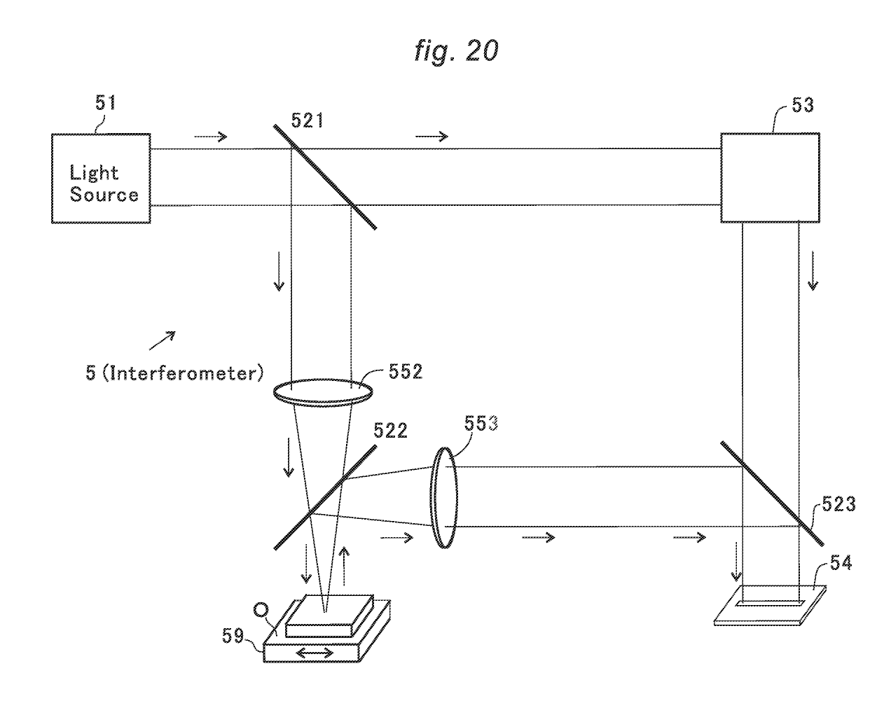

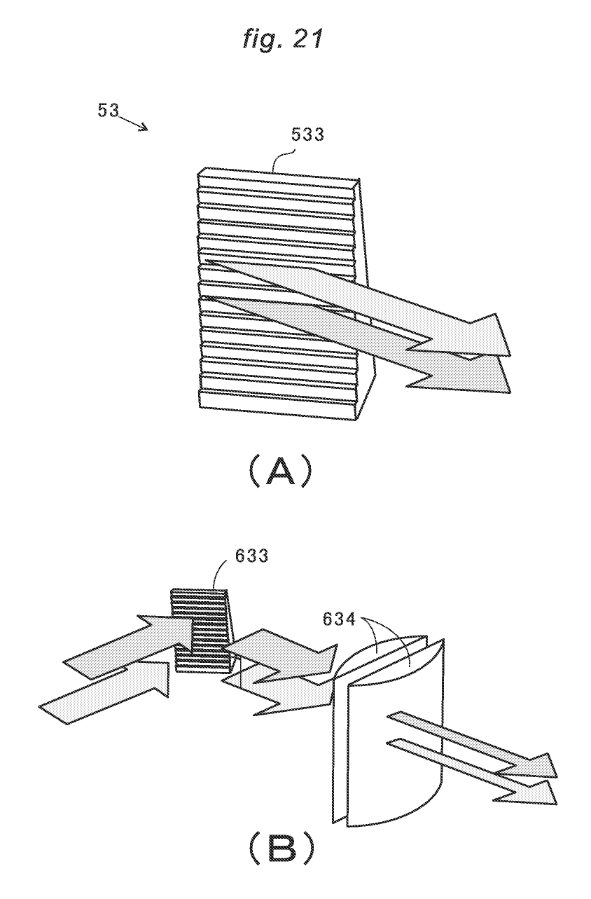

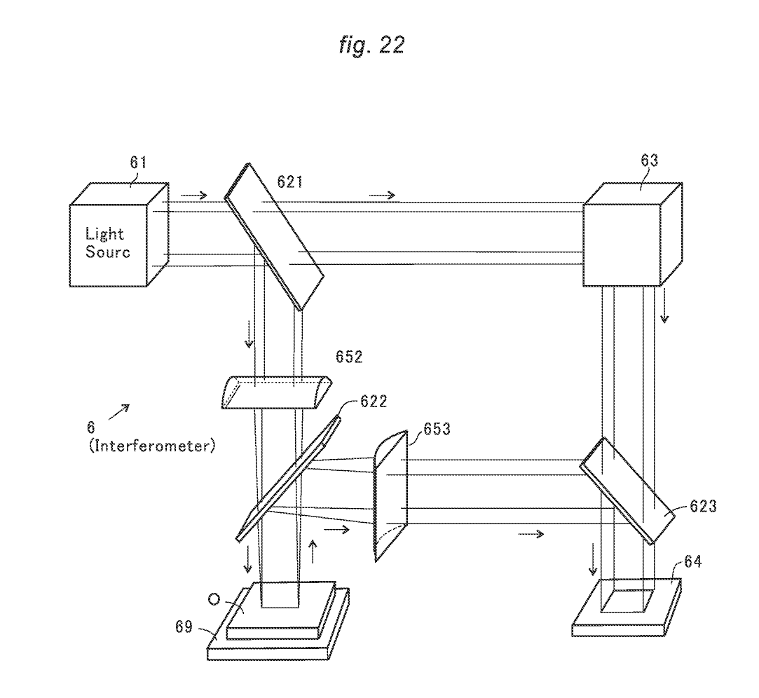

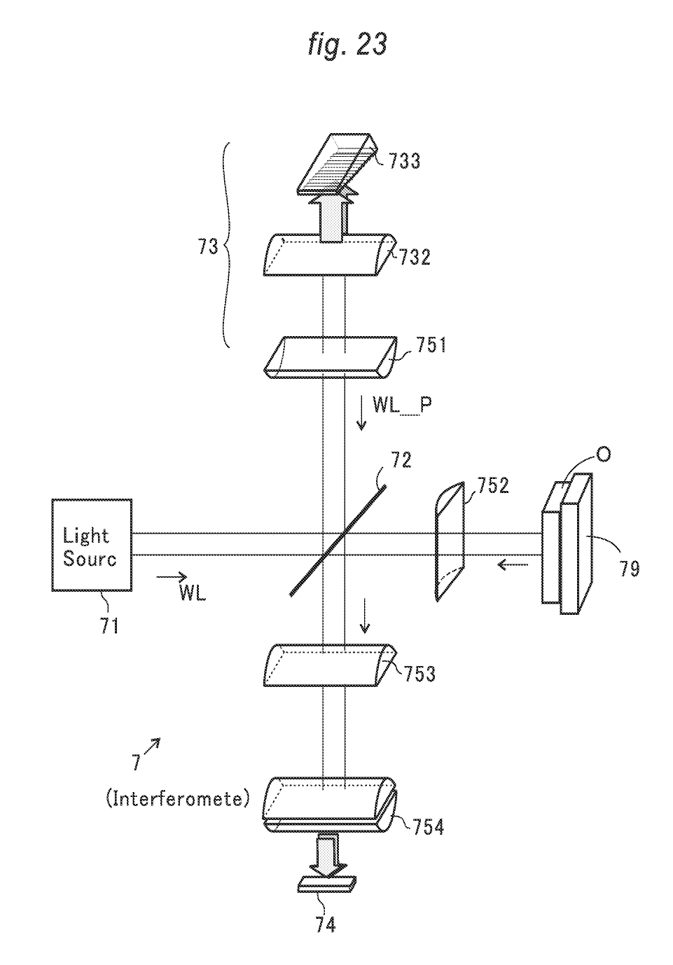

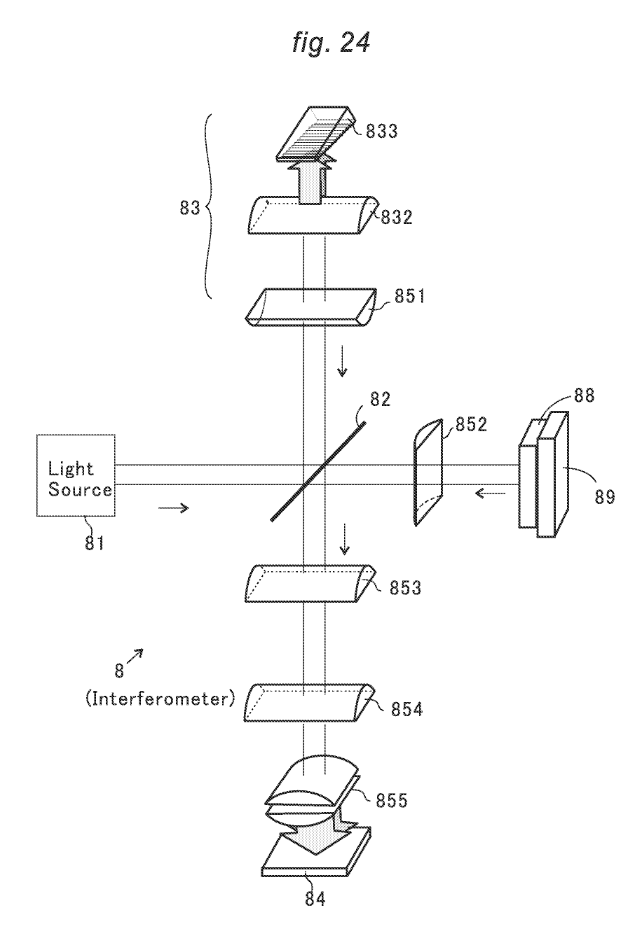

The second embodiment of object the measurement device 200 of the present invention is explained from FIG. 10 by FIG. 16.

In the first embodiment, the total reflection mirror 124 was set at the position of the measurement object O.

And reference wave Sᵣ was measured, and interference light (autocorrelation Iᵣᵣ (ω)) was executed Fourier transform of, and electric field spectrum Eᵣ (ω) was provided.

However, the total reflection mirror 124 is not used in the present embodiment, and electric field spectrum Eᵣ (ω) of the reference wave Sᵣ is got directly.

That is, in the present embodiment, electric field spectrum of reference wave Sᵣ is demanded.

Electric field spectrum of measurement wave Sₛ is got from the electric field spectrum and cross-correlation of reference wave Sᵣ and measurement wave Sₛ.

And space information, energy structural information, an refractive index, a transmission factor, reflectance of the measurement object are acquired.

### First Constitutional Example

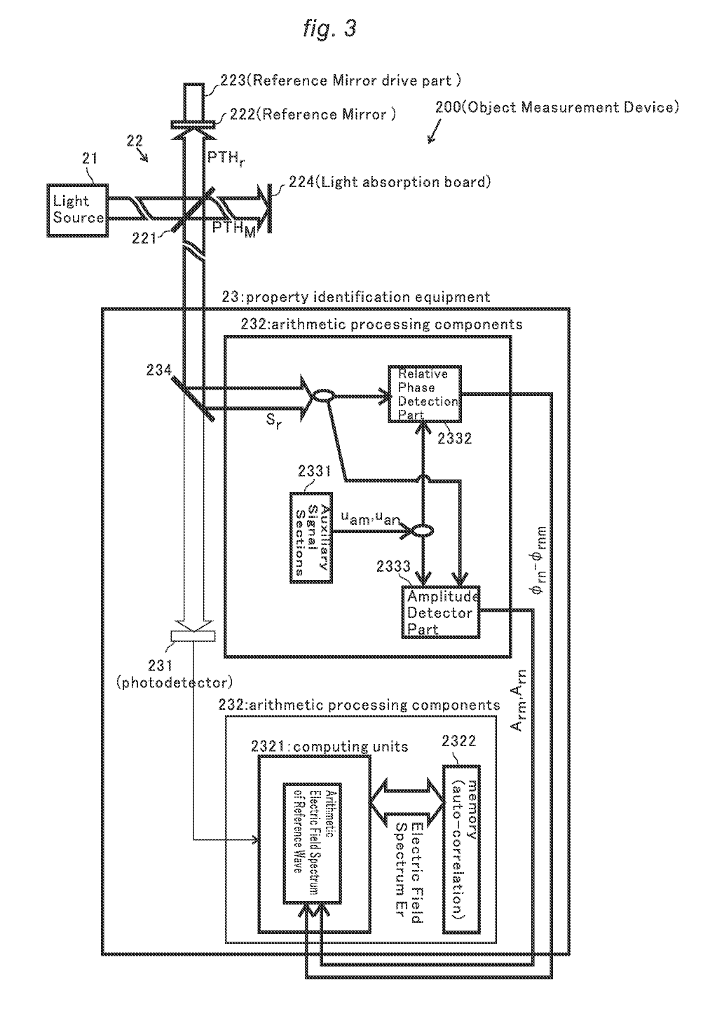

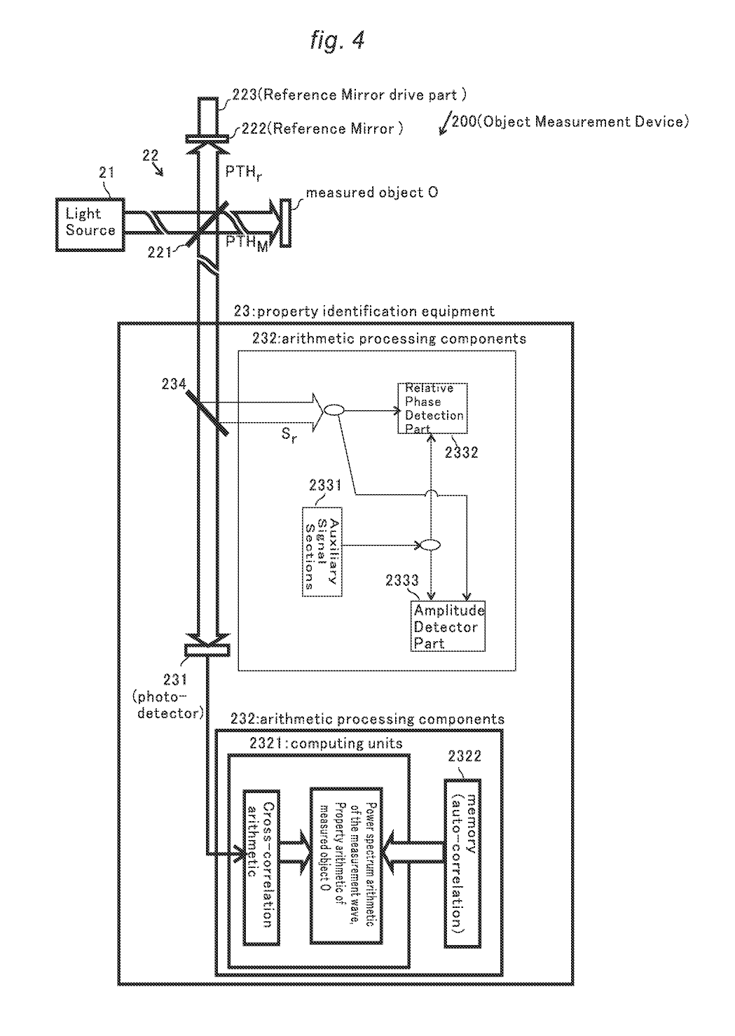

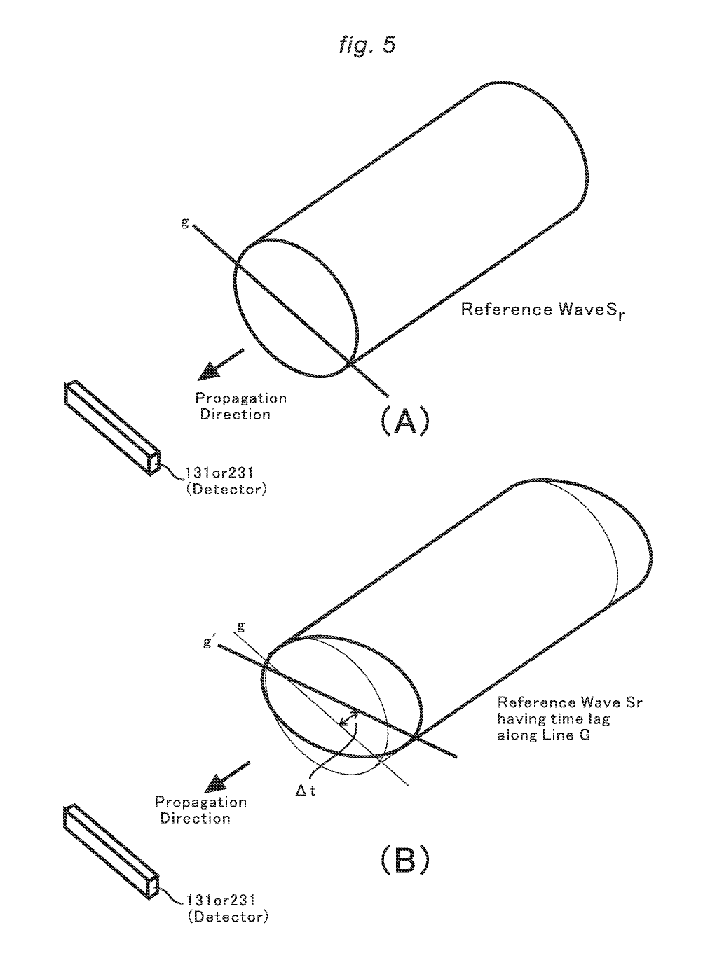

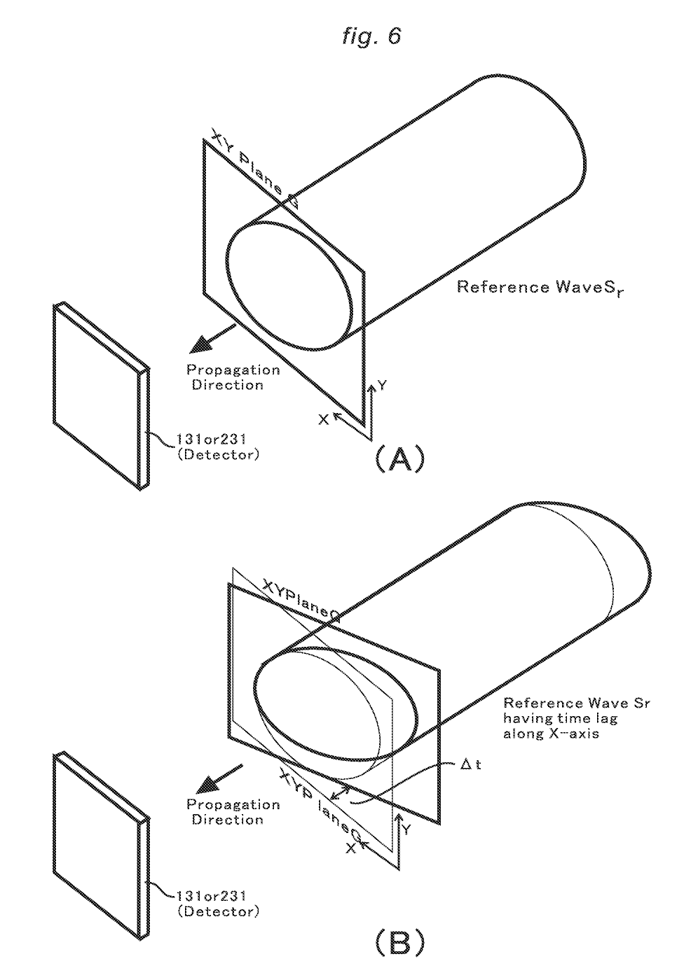

In FIG. 10, a object measurement device 200 is the object measurement device 200 which illustrated by FIG. 3 and FIG. 4.

The property identification device 23 becomes from the photo detector 231, the arithmetic processing component 232, the electric field spectrum measurement part 233 and the beam splitter 234.

It changes the combination of the reference wave component and, in FIG. 10, executes the process that the property identification device 23 detects relative phase and magnitude serially (it takes a serial step).

In FIG. 10, the property identification device 23 chooses two reference wave components sᵣₘ, sᵣₙ (typically n=m+1) in reference wave reference wave component Sᵣ₁, sᵣ₂, . . . , s_{rq} (arranged in low order of the frequency) included in Sᵣ.

The electric field spectrum measurement part 233 comprises auxiliary signal generation part 2331, relative phase detecting part 2332, magnitude detecting part 2333 and frequency selectivity region 2334 in this constitutional example as illustrated by FIG. 3 and FIG. 4.

Also, the arithmetic processing component 232 comprises arithmetic unit 2321 and the memory 2322.

In this constitutional example, electric field spectrum Eᵣ (ω) of reference wave Sᵣ can be measured by the electric field spectrum measurement part 233.

In this case, the light absorption board 224 is set at position of the measurement object O, and the photo detector 231 detects only reference wave Sᵣ.

And electric field spectrum measurement part 233 takes reference wave Sᵣ through the beam splitter 234.

Frequency selectivity part 2334 selects two reference wave components from a plurality of reference wave components sᵣ₁, sᵣ₂, . . . , s_{rq} which frequency is different.

A plurality of reference wave components sᵣ₁, sᵣ₂, . . . , s_{rq} are included in reference wave Sᵣ as a frequency component.

The selected reference wave components are defined in sᵣₘ, Sᵣₙ.

Note that the reference wave components sᵣ₁, sᵣ₂, . . . , s_{rq} can be determined as discrete value optionally.

Components sᵣₘ, sᵣₙ are two reference wave components which frequency was next to.

Auxiliary signal generation part 2331 generates two auxiliary signals uₐₘ, uₐₙ where middle value of the frequency was set between frequency of reference wave components sᵣₘ, Sᵣₙ.

The frequency interval of two auxiliary signals uₐₘ, uₐₙ are the same as a frequency interval of two reference wave components sᵣₘ, sᵣₙ.

Relative phase detecting part 2332 detects relative phase of reference wave components sᵣₘ, sᵣₙ from reference wave components sᵣₘ, sᵣₙ and auxiliary signal uₐₘ, uₐₙ.

The amplitude detecting part 2333 detects an amplitude Aᵣₘ of the reference wave component sᵣₘ from the reference wave components sᵣₘ, sᵣₙ and the auxiliary signal uₐₘ, and detects the amplitude Aᵣₙ of the reference wave component sᵣₙ from the reference wave component Sᵣₘ, Sᵣₙ and the auxiliary signal uₐₘ.

The magnitude detecting part 2333 detects the magnitude Aᵣₘ of the reference wave component sᵣₘ from the reference wave components sᵣₘ, sᵣₙ and the auxiliary signal uₐₘ.

The magnitude detecting part 2333 detects the magnitude Arn of the reference wave component sᵣₙ from the reference wave components sᵣₘ, sᵣₙ and the auxiliary signal uₐₙ.

The detection of these relative phase and the detection of the magnitude are performed about a group of the large number of the reference wave components sᵣₘ, sᵣₙ.

The arithmetic unit 2321 takes these detection results sequentially and records to the memory 2322.

The arithmetic unit 2321 can operate electric field spectrum Eᵣ(ω) of reference wave Sᵣ based on these record results.

And it measures cross-correlation with the reference wave Sᵣ and the measurement wave Sₛ as having illustrated by FIG. 4 and can derive electric field spectrum Eᵣ (ω) of the measurement wave Sₛ.

Because this cross-correlation is executed Fourier transform of, electric field spectrum Eᵣ (ω) of measurement wave Sₛ is got, and various kinds of properties of the measurement object O are measured.

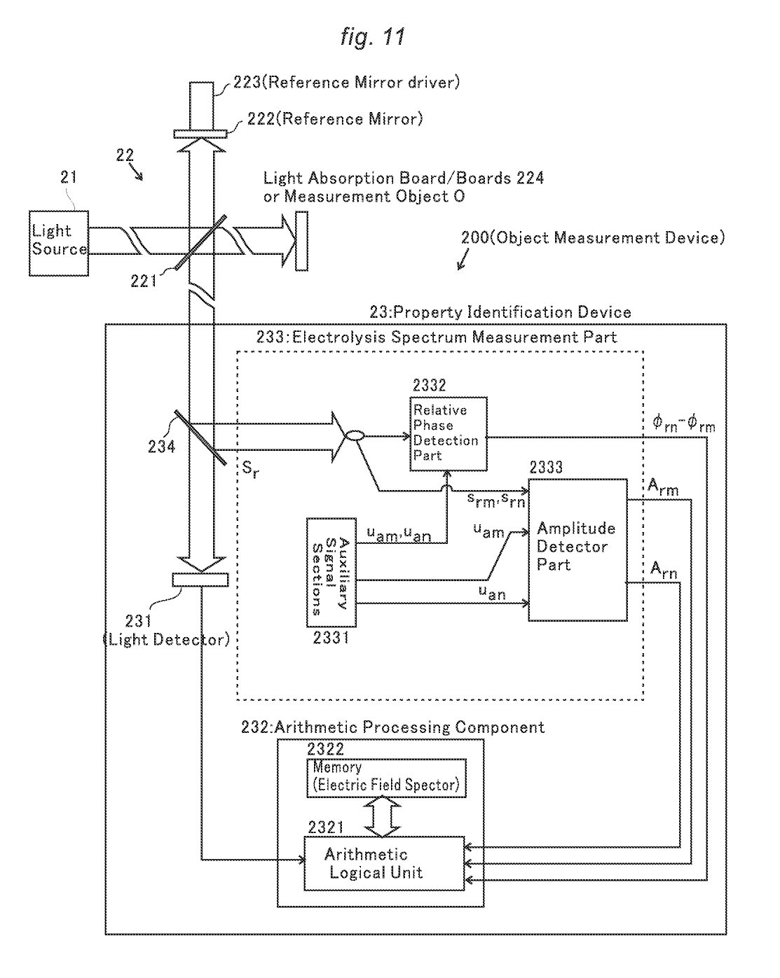

Configuration of the relative phase detecting part 2332 and configuration of the magnitude detecting part 2333 are shown in FIG. 11.

The relative phase detecting part 2332 consists of an coupler(CP), a photo diode (PD), band pass filter (BPF), a divider (DV), a mixer (MX) and the relative phase arithmetic logical unit (RPP).

In this constitutional example, the reference wave component sᵣₘ is represented by expression (33), and the reference wave component sᵣₙ is represented by expression (34).

sᵣₘ=Aᵣₘexp{j(ωᵣₘt−φᵣₘ)} (33)

sᵣₙ=Aᵣₙexp{j(ωᵣₙt−φᵣₙ)} (34)

Aᵣₘ is magnitude of sᵣₘ, ωᵣₘ is frequency of sᵣₘ and φᵣₘ is a phase of sᵣₘ.

Aᵣₙ is magnitude of sᵣₙ, ωᵣₙ is frequency of sᵣₙ and φᵣₙ is a phase of sᵣₘ.

φᵣₙ−φᵣₘ is unknown value.

Note that one of φᵣₘ and φᵣₙ may be known. However, both of φᵣₘ and φᵣₙ are usually unknown.

The auxiliary signal uₐₘ which the auxiliary signal generation part 2331 generates may be represented by expression (35). The auxiliary signal uₐₙ which the auxiliary signal generation part 2331 generates may be represented by expression (36).

uₐₘ=Aₐₘexp{j(ωₐₘt−φₐₘ)} (35)

uₐₘ=Aₐₙexp{j(ωₐnt−φₐₙ)} (36)

Aₐₘ is magnitude of uₐₘ, ωₐₘ is frequency of uₐₘ and φₐₘ is a phase of uₐₘ. Aₐₙ is magnitude of uₐₙ, ωₐₙ is frequency of uan and φₐₙ is a phase of Uₐₙ.

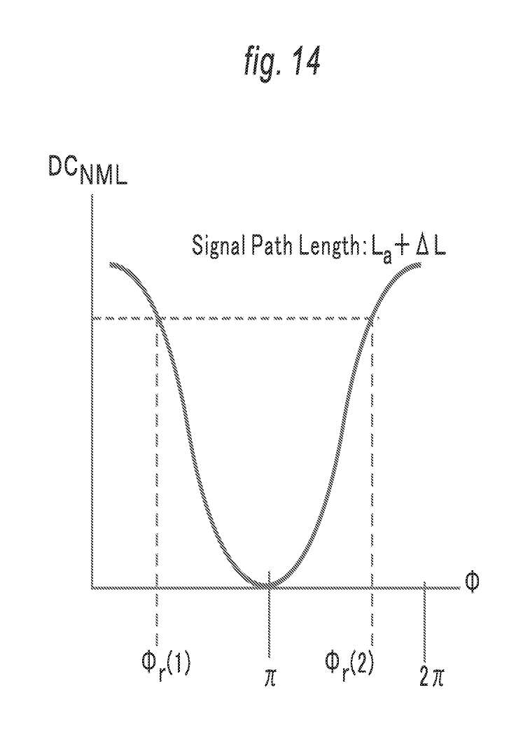

A frequency interval Ω_{D} of the auxiliary signals uₐₘ, uₐₙ is the same as a frequency interval of the reference wave components sᵣₘ, sᵣₙ as shown in FIG. 14.

A middle value (ωₐₙ−ωₐₘ)/2 of the frequency ωᵣₙ and the frequency ωₐₘ is set between two frequency ωᵣₙ and ωᵣₘ. reference wave component sᵣₘ, frequency of sᵣₙ.

ωᵣₙ is the frequency of the reference wave component sᵣₙ, ωᵣₘ is the frequency of the reference wave component sᵣₙ.

Frequency difference between reference wave component sᵣₘ and auxiliary signal uₐₘ (or frequency difference between reference wave component sᵣₙ and auxiliary signal uₐₙ) is defined as Δω. That is, the next ceremony is passed.

That is, the next formula consists.

Δω=ωᵣₘ−ωₐₘ=ωᵣₙ−ωₐₙ

Relation of expression (37) consists between Δω and Ω_{D} in this constitutional example.

|Δω|<|Ω_{D}|/2 (37)

The auxiliary signal uₐₘ, uₐₙ are represented by expression (38), expression (39).

uₐₘ=Aₐₘexp[{j(ωᵣₘ−Δω)t−φₐₘ}] (38)

uₐₙ=Aₐₙexp[{j(ωₐₘ−Δω)t−φₐₙ}] (39)

The relative phase detecting part 2332 acquires sᵣₘ, sᵣₙ through optical divider c₁.

The beat signal B_{T1} and beat signal B_{T2} are generated by the reference wave component sᵣₘ, sᵣₙ and the auxiliary signal uₐₘ, uₐₙ.

The beat signal B_{T1} is generated from the reference wave component sᵣₘ that frequency is lower and the auxiliary signal uₐₘ that frequency is lower.

The beat signal B_{T2} is generated from the reference wave component sᵣₙ that the frequency is higher and the auxiliary signal uₐₙ that the frequency is higher.

And multiplication signal of these two beat signals B_{T1}, B_{T2} is generated.

The coupler CP couples two reference wave component sᵣₘ, sᵣₙ and two auxiliary signal uₐₘ, uₐₙ and generates coupling signal. And this coupled signal is executed photo-electric translation by photo diode (PD).

Output of the photo diode (PD) includes beat signal B_{T1} and beat signal B_{T2}.

The beat signal B_{T1} is generated by the reference wave component sᵣₘ and the auxiliary signal uₐₘ.

The beat signal B_{T2} is generated by reference wave component sᵣₙ and the auxiliary signal uₐₙ.

The band pass filter (BPF) extracts beat signal B_{T1} and B_{T2} (frequency Δω) from these beat signal.

B_{T1} is a beat signal of frequency Δω occurring because of the reference wave component sᵣₘ and the auxiliary signal uₐₘ.

B_{T2} is a beat signal of frequency Δω occurring because of the reference wave component sᵣₙ and the auxiliary signal uₐₘ.

A output of the band pass filter (BPF) includes section as shown in the expression (40).

2AᵣₘAₐₘ cos {Δωt+(φᵣₘ−φₐₘ)+cnst₁}]+2AᵣₙAₐₙ cos {Δωₜ+(φᵣₙ−φₐₙ)+cnst₂}] (40)

Here,

cnst₁=(2π/c)×[ωᵣₘnᵣLᵣ−ωₐₘnₐLₐ])

cnst₂=(2π/c)×[ωᵣₙnᵣLᵣ−ωₐₙnₐLₐ])

c: light velocity

nᵣ: refractive index of reference wave path

nₐ: refractive index of auxiliary signal path

Lᵣ: reference wave path length

Lₐ: auxiliary signal paths length

First term of the expression (40) is element of beat signal B_{T1}.

Second term of the expression (40) is element of beat signal B_{T2}.

Output of the band pass filter (BPF) (Bₑₐₜ signal B_{T2}) is divided into two paths by a divider (DV).

T_{ww} signals via two paths are multiplied by a mixer (MX).

Output of the mixer (MX) (multiplication signal MPL) is represented like expression (41).

This embodiment is simplized, φₐₙ equals φₐₘ (φₐₙ=φₐₘ).

MPL=(Aᵣₘ²Aₐₘ²+Aᵣₙ²Aₐₙ²)/2+AᵣₘAᵣₙAₐₘAₐₙ cos(cnst₂−cnst₁)+R(Δωt) (41)

The term (cnst₂−cnst₁) of expression (41) is represented by an expression (42).

cnst₂−cnst₁=(2π/c)×[(ωᵣₙnᵣ−ωᵣₘₙᵣ)Lᵣ−(ωₐₘnₐ−ωₐₙnₐ)Lₐ] (42)

R(Δωₜ) in expression (41) is a facility depending on product of beat frequency and time.

Relative phase arithmetic logical unit (RPP) withdraws DC of multiplication signal MPL as described below (cf. expression (43) and expression (44)).

Relative phase arithmetic logical unit (RPP) removes constant to be decided by detection system from the DC component.

Relative phase arithmetic logical unit (RPP) detects relative phase (φᵣₙ−φᵣₘ) of two reference wave components sᵣₘ, Sᵣₙ.

Direct current component DC of multiplication signal MPL is represented based on expression (41) as follows.

DC=(Aᵣₘ²Aam²+Aᵣₙ²Aₐₙ²)/2+AᵣₘAᵣₙAₐₘAₐₙ cos [(φᵣₘ−φᵣₙ)+(cnst₂−cnst₁)] (43))

Only cosine portion is extracted by this expression, and it is normalized.

Normalized direct current component DC_{NML} is represented like expression (44).

Note that AᵣₘAᵣₙAₐₘAₐₙ is value measured beforehand.

DC_{NML}=cos [(φᵣₙ−φᵣₘ)+(cnst₂−cnst₁)] (44))

Two reference wave component sᵣₘ, relative phase Φᵣ(=(φᵣₙ−φᵣₙ)) of sᵣₙ are got by this normalized DC DC_{NML} by removing an element (constant (cnst₂−cnst₁) decided by detection system) that does not depend on the phase.

Note that (44), by the expression, it omits (half) for offset, and it is shown.

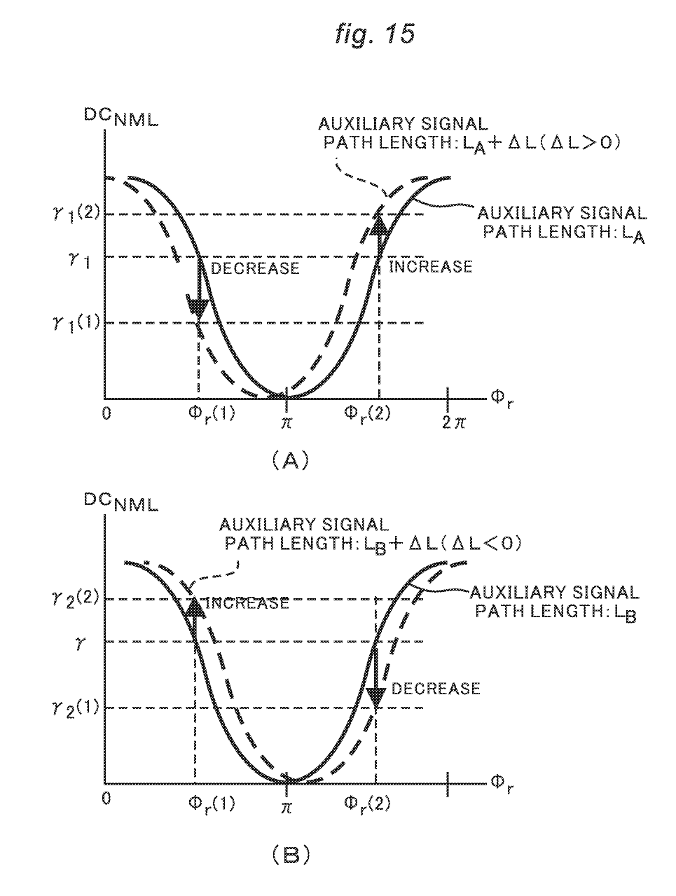

The relationship between normalized direct current component DC_{NML} and relative phase Φᵣ is shown in FIG. 15.

As shown in FIG. 15, relative phase arithmetic logical unit (RPP) usually detects two relative phase Φ_{r (1)}, Φ_{r (2)} in appearance about a certain DC_{NML}.

Φ_{r (1)} is between zero−π[rad], and Φ_{r (2)} is between 2π−π[rad].

Relative phase of reference wave components sᵣₘ, sᵣₙ are in (0−π) [rad] or in (n−2π) [rad]. The relative phase of two reference wave components sᵣₘ, sᵣₙ belong to either of two zone.

But, nobody can know phase angle zone that the relative phase belongs.

In this case, either part of a reference wave path or the auxiliary signal path can be provided with signal path length modulation region.

The signal path length modulation department can be had built-in to auxiliary signal generation part 2331.

One of two “relative phase Φᵣ₍₁₎, Φᵣ₍₂₎ in the appearance” which it showed in FIG. 15 is identified as “true relative phase”.

For example, it supposes supporting signal path length La that only a micro distance was extended.

Then value of cnst₂−cnst₁ of expression (42) turns small.

It supposes supporting signal path length La that only a micro distance was shortened.

Then value of cnst₂−cnst₁ of expression (42) turns large.

For example, it supposes supporting signal path length Lᵣ that only a micro distance was extended.

Then value of cnst₂−cnst₁ of expression (42) turns large.

It supposes supporting signal path length Lᵣ that only a micro distance was shortened.

Then value of cnst₂−cnst₁ of expression (42) turns small.

For example, value of DC_{NML} is γ, and it is assumed that two relative phases Φ_{A (1)}, Φ_{A (2)} were detected in an appearance (cf. FIG. 15).

In this case, it is assumed that it changed supporting signal path length Lₐ into Lₐ+ΔL (ΔL>0).

As shown in FIG. 16 (A), the signal path length characteristic varies from Lₐ (a solid line) to Lₐ+ΔL (a broken line).

If DC_{NML} decreased to γ₍₁₎ then, it is determined that Φᵣ₍₁₎ is “true relative phase”.

If DC_{NML} increased to γ₍₂₎, it is determined that Φᵣ₍₂₎ is “true relative phase”.

Also, it is assumed that it changed supporting signal path length Lₐ into Lₐ+ΔL (ΔL<0).

In this case, as shown in FIG. 15 (B), signal path length characteristic varies from La (a solid line) to Lₐ+ΔL (a broken line).

If DC_{NML} decreased to γ₍₁₎ then, it is determined that Φ_{r (2)} is “true relative phase”.

If DCNML increased to γ₍₂₎, it is determined that Φr(1) is “true relative phase”.

### Second Constitutional Example

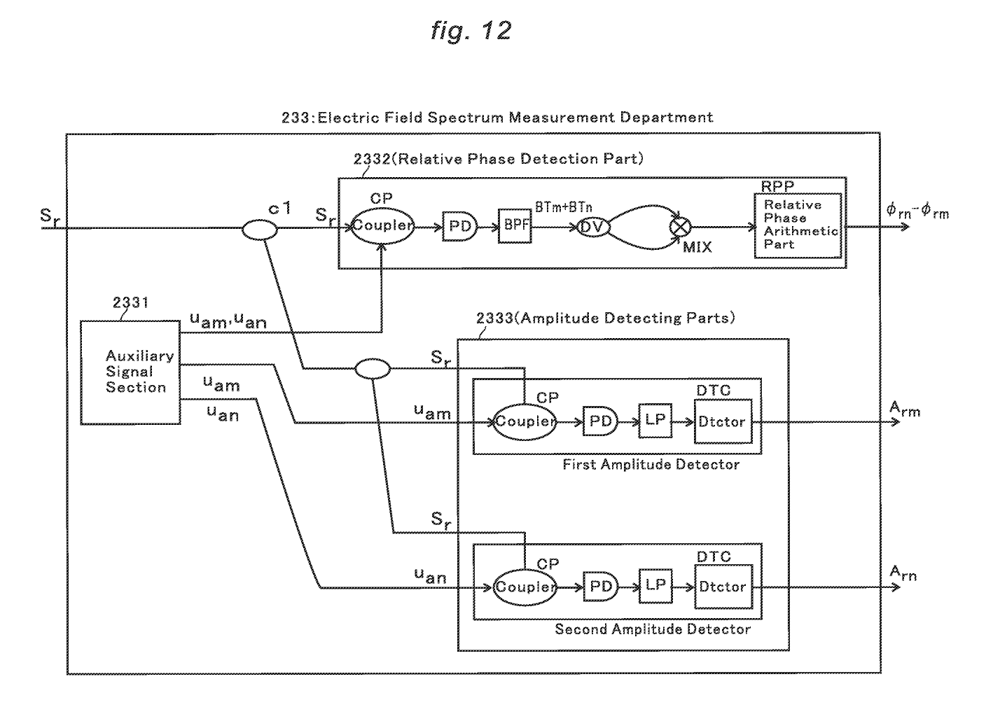

A frequency selectivity part is removed from the object measurement device 200 of FIG. 3 and FIG. 4, the object measurement device 200 of FIG. 12 is thereby constructed.

The property identification device 23 becomes from the photo detector 231, the arithmetic processing component 232, the electric field spectrum measurement part 233 and the beam splitter 234.

In FIG. 12, the property identification device 23 extracts reference wave components sᵣ₁, sᵣ₂, . . . , s_{rN} (arranged in low order of the frequency) where frequency components are different from reference wave Sᵣ in a lump.

A group of two reference wave components sᵣₘ, sᵣₙ (typically n=m+1) in these is chosen.

And process to detect relative phase and magnitude changes combination of the reference wave component, and it is executed multiply (it makes parallel processing).

The property identification device 23 becomes from the photo detector 231, the arithmetic processing component 232 and the electric field spectrum measurement part 233.

In this constitutional example, the electric field spectrum measurement part 233 comprises an auxiliary signal generation part 2331, a relative phase detecting part 2332, a magnitude detecting part 2333 and a frequency resolution region 2335.

Also, in this constitutional example, the arithmetic processing component 232 comprises arithmetic unit 2321 and the memory 2322.

In this constitutional example, electric field spectrum Eᵣ(ω) of the reference wave Sᵣ can be measured by electric field spectrum measurement part 233 like the first constitutional example.

In this case, the light absorption board 224 is set at position of the measurement object O, and the photo detector 231 can detect only reference wave Sr.

And electric field spectrum measurement part 233 takes reference wave Sᵣ through the beam splitter 234.

Frequency resolution department 2335 generates a plurality of reference wave components Sᵣ₁, Sᵣ₂, . . . , Sᵣ which are included in reference wave Sᵣ as frequency component.

Auxiliary signal generation part 2331 generates two auxiliary signals that frequency interval is the same as the frequency interval of two adjacent reference wave components.

Frequency middle value of two auxiliary signals is set between frequency of two adjacent reference wave components.

Relative phase detecting part 2332 detects relative phase of reference wave components sᵣₖ, sᵣ₍ₖ₊₁₎ from synthesized wave with two adjacent reference wave components sᵣₖ, sᵣ₍ₖ₊₁₎ and auxiliary signals uₐₖ, uₐ₍ₖ₊₁₎.

In this constitutional example, relative phases of (q−1) units are detected at the same time.

The magnitude detecting part 2333 detects the magnitude Aᵣₖ of reference wave component sᵣₖ from processed signals in relative phase detecting part 2332.

In this constitutional example, the magnitudes Aᵣₖ of q units are detected at the same time (k=1, 2, . . . , q).

Arithmetic unit 2321 takes a detection result of these relative phase and a detection result of the magnitude.

Detection result is recorded to the memory 2322.

Electric field spectrum Eᵣ (ω) of the reference wave Sᵣ can be operated by these record results.

That is, it measures cross-correlation with reference wave Sᵣ and measurement wave Ss as having illustrated by FIG. 4 and can derive electric field spectrum Eᵣ (ω) of crowd Ss measuring that Fourier transform does this and can measure various kinds of property of the measurement object O.

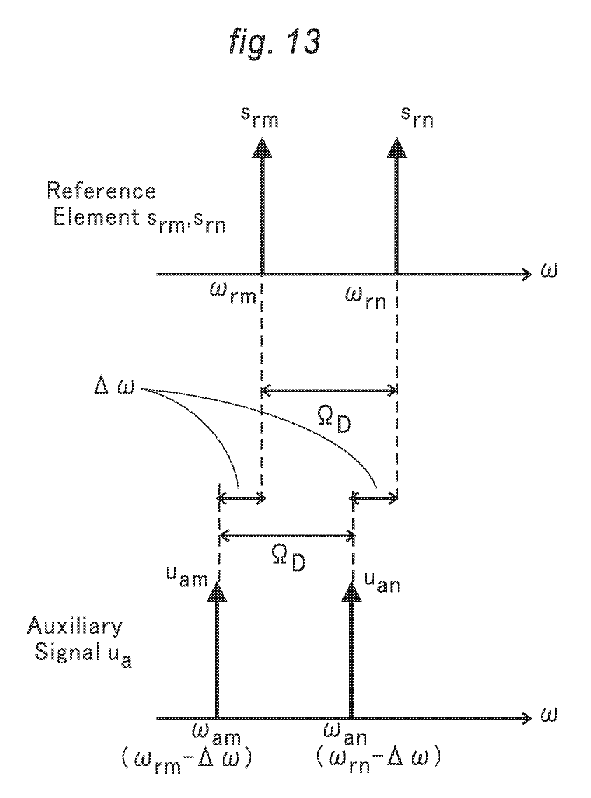

It shows configuration of relative phase detecting part 2332 and amplitude detecting part 2333 in FIG. 13.

The relative phase detecting part 2332 comprises of an arrayed-waveguide grating (AWG) with the q-output terminals,

a group (PDG) of photodiodes (PD) which it provided in the output side,

a signal selective circuit (SLCT) which respectively selects two signals from output signals of PDG,

a group (MIXG) of (q−1) mixer units to multiply output signals of SLCT,

a relative phase arithmetic logical unit (RPP) which it inputs output signals of MIXG and detects relative phase.

In this embodiment, the beat signal B_{T1} of Sᵣ₁ and uₐ₁, the beat signal B_{T2} of Sᵣ₂ and uₐ₂, . . . , the beat signal B_{Tq} of s_{rq} and u_{aq} are input into the signal selective circuit SLCT.

The signal selective circuit SLCT selects beat signal like (B₁, B₂), (B₂, B₃), (B₃, B₄), . . . , (B_{N-1}, B_{N}) so that “overlap is permitted”.

All beat signals are thereby connected through phase.

Mixers of (N−1) units to comprise mixer group MIXG multiply two beat signals.

Multiplication signal (multiplication of k-th beat signal and (k+1)-th beat signal) is sent out to the first relative phase arithmetic logical unit of the relative phase arithmetic logical unit RPP.

In the k-th relative phase arithmetic logical unit, a constant to be decided by the detection system is removed from DC component of each multiplication signal of MIXG A constant to be decided is removed from the DC of each multiplication signal of MIXG in the k-th relative phase arithmetic logical unit (k=1, 2, . . . , q−1) by detection system.

The magnitude detecting part 2333 consists of

a 1st magnitude arithmetic logical unit,

a 2nd magnitude arithmetic logical unit,

a 9th magnitude arithmetic logical unit.

The magnitude Aᵣₖ of the reference wave component sᵣₖ is detected by magnitude of the k-th beat signal.

The relative phase φᵣ₍ₖ₊₁₎−φᵣₖ and the magnitude Aᵣₖ are memorized as electric field spectrum Eᵣ (ω) to the memory 2322 of the arithmetic processing component 232.

In this example, generation of the beat signal, multiplication of the beat signal, detection process of relative phase and magnitude detection are executed in parallel by using the AWG 321.

Thus, high-speed arithmetic becomes possible.

Two solutions of the relative phase may produce even the object measurement device 200 of this constitutional example like constitutional example 1.

In this case, signal path length (optical path length) is modulated by signal path length modulation part with constitutional example 1 similarly.

“True relative phase” is thereby determined.

### DENOTATION OF REFERENCE NUMERALS

5, 6, 7, 8, 12, 22 interferometer
11, 21, 51, 61, 71, 81 light source
13, 23 property identification device
24, 54, 64, 74, 84,131,231 photo detector
42, 72, 75, 121, 221, 2324 beam splitter
49, 59, 69, 79 translation stage
53, 63, 73, 83 modulator
100,200 object measurement device
122,222 reference mirror
123,223 reference mirror drive
124 total reflection mirror
132,232 the arithmetic processing component
224 light absorption board
233 electric field spectrum measurement part
321 AWG
353, 522, 551, 552, 553, 621, 651, 652, 751, 753, 851, 852, 853 lens system
521, 522, 621, 623, 632 beam splitter
532, 632, 732, 733, 832 cylindrical lens
533, 633, 833 modulation mirrors
1321, 2321 arithmetic units
1322, 2322 memories
2331 auxiliary signal sections
2332 relative phase detecting parts
2333 amplitude detecting parts
2334 frequency selectivity part
2335 frequency resolution department

1. A spectrum measurement device which receives a reference wave propagating in a reference path and a measurement wave propagating in a measurement path having a start point same as a start point of the reference path, and derives a spectrum of the measurement wave,
wherein the spectrum is a spectrum of measurement wave that is turned back on surface or inside of a measurement object,
or a spectrum of measurement wave that penetrates the measurement object,
a spectrum of the measurement wave is measured based on spectrum of the reference wave and a signal being proportional to square of an synthesized wave of the reference wave and the measurement wave.

2. A spectrum measurement device according to claim 1,
wherein spectrum of the measurement wave is power spectrum and the power spectrum is represented by next expression.
[a spectrum provided by executing Fourier transform of signal proportionate to square of an synthesized wave of a reference wave and a measurement wave]²/[a spectrum of a reference wave]

3. An object measurement device comprising a property identification device,
wherein the property identification device has a facility of the spectrum measurement device described in claim 1,
the reference wave path and the measurement wave path have the same start point,
the measurement wave path is formed to be turned back on surface or inside of a measurement object, or to penetrate the measurement object,
the property identification device derives property information (for example, at least one of space information, energy structural information, refractive index, transmission factor and reflectance) of the measurement device based on spectrum of the measurement wave.

4. An object measurement device according to claim 3,
wherein the reference wave has a characteristic that delay time or advance time changes gradually along a virtual line which is perpendicular to a propagation direction,
or, the reference wave has a characteristic that delay time or advance time changes gradually along a virtual line on a virtual XY plane which is perpendicular to a propagation direction.

5. A spectrum measurement device receives reference wave propagating in a reference path, and receives measurement wave propagating in a measurement path having a start point same as a start point of the reference path, derives spectrum of the measurement wave,
wherein a spectrum of the reference wave is derived,
at the same time, Fourier transform of cross-correlation between the reference wave and the measurement wave is got,
the spectrum of the measurement wave is got based on the spectrum of the reference wave and the Fourier transform of the cross-correlation.

6. An object measurement device comprising a property identification device,
wherein the property identification device has facility of the spectrum measurement device described in claim 5,
a reference wave path and the measurement wave path have the same start point,
the measurement wave path is formed to be turned back on surface or inside of a measurement object, or to penetrate the measurement object,
the property identification device derives property information (for example, at least one of space information, energy structural information, refractive index, transmission factor and reflectance) of the measurement device based on spectrum of the measurement wave.

7. An object measurement device according to claim 6,
wherein the reference wave has a characteristic that delay time or advance time changes gradually along a virtual line which is perpendicular to a propagation direction,
or, the reference wave has a characteristic that delay time or advance time changes gradually along a virtual line on a virtual XY plane which is perpendicular to a propagation direction.

8. A spectrum measurement device which receives
a reference wave propagating in a reference path and
a first measurement wave, a second measurement wave, . . . , a N-th measurement wave propagating in a first measurement paths, a second measurement paths, . . . , a N-th measurement paths having a start point same as a start point of the reference path, and derives spectra of the first, the second, . . . , the N-th measurement wave,
wherein the spectra are
spectra of the first measurement wave, the second measurement wave, . . . , the N-th measurement wave which are turned back on surface or inside of a measurement object, or
spectra of the first measurement wave, the second measurement wave, . . . , the N-th measurement wave which penetrate the measurement object;
spectra of the first measurement wave, the second measurement wave, . . . , the N-th measurement wave are measured based on spectra of the reference wave and signals being proportional to square of each synthesized wave of the reference wave and the 1st, the 2nd, . . . , the N-th measurement wave.

9. The spectrum measurement device according to claim 8,
wherein each spectrum of the first measurement wave, the second measurement wave, . . . , the N-th measurement wave is power spectrum,
the power spectrum of the k-th measurement wave (k: 1, 2, . . . or N) is represented by next expression.
[a spectrum provided by executing Fourier transform of signal proportionate to square of an synthesized wave of a reference wave and a k-th measurement wave]²/[a spectrum of a reference wave]

10. An object measurement device comprising a property identification device,
wherein the property identification device has facility of the spectrum measurement device described in claim 9,
the reference wave path and a first measurement wave path, a second measurement wave path, . . . , the N-th wave path have the same start point,
the first measurement wave path, the second measurement wave path, . . . , the N-th measurement wave path are formed to be turned back on surface or inside of a measurement object, or to penetrate the measurement object,
the property identification device derives property information of the measurement device based on spectra of a first measurement wave, a second measurement wave, . . . , a N-th measurement wave.

11. Object measurement device according to claim 10,
wherein the reference wave has a characteristic that delay time or advance time changes gradually along a virtual line which is perpendicular to a propagation direction,
or, the reference wave has a characteristic that delay time or advance time changes gradually along a virtual line on a virtual XY plane which is perpendicular to a propagation direction.

12. A spectrum measurement device which receives a reference wave propagating in a reference path and a first measurement wave, a first measurement waves, a second measurement wave, . . . , a N-th measurement wave propagating in a first measurement path, a second measurement path, . . . , a N-th measurement path having respectively a start point same as a start point of the reference path, and derives electric field spectra of the first measurement wave, the second measurement wave, . . . N-th measurement wave,
wherein Fourier transform of the cross-correlation between the reference wave and the first measurement wave, the second measurement wave, . . . , the N-th is respectively derived, and the electric field spectra are measured based on the spectra of the reference wave and Fourier transform of the cross-correlation.

13. An object measurement device comprising a property identification device,
wherein the property identification device has facility of the spectrum measurement device described in claim 12,
a reference wave path and a first measurement wave path, a second measurement wave path, . . . , a N-th measurement wave path have the same start point,
the first measurement wave path, the second measurement wave path, . . . , the N-th measurement wave path are formed to be turned back on surface or inside of a measurement object, or to penetrate the measurement object,
the property identification device derives property information of the measurement device based on spectrum of the first measurement wave, the second measurement wave path, . . . , the N-th measurement wave.

14. An object measurement device according to claim 13,
wherein the reference wave has a characteristic that delay time or advance time changes gradually along a virtual line which is perpendicular to a propagation direction,
or, the reference wave has a characteristic that delay time or advance time changes gradually along a virtual line on a virtual XY plane which is perpendicular to a propagation direction.
